(19) United States
(12) Patent Application Publication
(10) Pub. No.: US 2026/0181348 A1
(43) Pub. Date: Jun. 25, 2026

(54) ADAPTIVE CONTROL OF LOUDSPEAKER DIRECTIVITY AND ADAPTIVE SWEETSPOT COMPENSATION

(71) Applicant: Bang & Olufsen A/S, Struer (DK)

(72) Inventors: Oliver SCHEUREGGER, Valby (DK); Gabriel SUC, Aarhus (DK); Jonas Martin HELM, Munich (DE)

(21) Appl. No.: 19/424,003

(22) Filed: Dec. 17, 2025

(30) Foreign Application Priority Data
Dec. 24, 2024 (EP) 24223246.0

(51) Int. Cl. H04S 7/00; H04R 3/12; H04R 5/02

(52) U.S. Cl. CPC H04S 7/303; H04R 3/12; H04R 5/02; H04S 2400/11

(57) ABSTRACT

Aspects provide methods of audio reproduction including determining dynamic position information including positions of one or more loudspeakers and/or a listener within the local reproduction system relative to a reference point. A method includes automatically applying one or more adaptive sweetspot parameters to an audio signal based on the dynamic position information and automatically controlling a directivity of the one or more loudspeakers based on the dynamic position information and the one or more adaptive sweetspot parameters. A method includes determining a directivity of the loudspeaker within the local reproduction system based on the dynamic position information and automatically enabling or disabling an adaptive sweetspot function based on the directivity of the loudspeaker. The methods include rendering the corrected audio signal to the local reproduction system based on the directivity of the one or more loudspeakers and the adaptive sweetspot parameters.

### CROSS-REFERENCE TO RELATED APPLICATION

This application claims priority to European Patent Application No. 24223246.0, filed Dec. 24, 2024, which is incorporated by reference herein in its entirety.

### FIELD

The present disclosure is related to sound reproduction systems and, more specifically, to reproduction of sound fields in systems using loudspeaker directivity and adaptive sweetspot compensation.

### BACKGROUND

Stereophonic sound, more commonly known as “stereo”, is a method of sound reproduction that uses at least two independent audio channels, through a configuration of at least two loudspeakers (or alternatively, a pair of two-channel headphones), to create a multi-directional and three-dimensional audio perspective that provides an audio experience to the listener that creates the impression of sound heard from various directions, as in natural hearing.

Surround sound refers to stereo systems using more than two audio channels, more than two loudspeakers, or both, to enrich the depth and fidelity of the sound reproduction. Stereo sound can be captured as live sound (e.g., using an array of microphones), with natural reverberations present, and then reproduced over multiple loudspeakers to recreate, as close as possible, the live sound. Pan stereo refers to a single-channel (mono) sound that is then reproduced over multiple loudspeakers. By varying the relative amplitude of the signal sent to each speaker, an artificial direction (relative to the listener) can be created.

One type of stereo audio is referred to as mid/side (M/S). A bidirectional microphone (e.g., with a figure eight pattern) facing sideways and a cardioid facing the sound source can be used to record mid/side audio. The “left” and “right” audio channels are encoded through a simple matrix: Left=Mid+Side and Right=Mid−Side, where “minus” means adding the side signal with the polarity reversed. The stereo width, and thereby the perceived distance of the sound source, can be manipulated after the recording.

Panning algorithms are capable of redistributing audio signals across a given array of transducers. Panning algorithms are used in both the creation of audio content (e.g., a studio mixing desk will typically have stereo pan-pots to position an audio signal across the left-right dimension), as well as in the rendering of audio (e.g., in consumer loudspeaker setups). Examples of panning algorithms include, but are not limited to, Vector Base Amplitude Panning (VBAP), Ambisonic panning (e.g., Ambisonic Equivalent Panning (AEP)), Distance Base Angular Panning (DBAP), Layer Base Amplitude Panning (LBAP), Dual Band Vector Base Panning (VBP Dual-Band), K-Nearest Neighbor (KNN) panning, Speaker-Placement Correction Amplitude Panning (SPCAP), Continuous Surround Panning (CSP), Angular and PanR panning,

In today's media-driven society, there are increasingly more ways for users to access video and audio, with a plethora of products producing sound in the home, car, or almost any other environment. Portable products producing audio, such as, for example, phones, tablets, laptops, headphones, portable loudspeakers, soundbars, and many other devices, are ubiquitous. These products for producing sounds may include, for example, a large variety of audio such as music, speech, podcasts, sound effects, and audio associated with video content.

Next Generation Audio (NGA) refers to developments in technologies that strive to create audio systems which are immersive, providing a user an enhanced immersive auditory experience; adaptive, capable of adapting to different acoustic environments, different listener/speaker locations, and different listening contexts; and interactive, allowing users to make conscious decisions to interact with the system such that the auditory experience is modified in a way that is intuitive and expected by the user. NGA technologies include, for example, rendering technologies, focused on digital processing of audio signals to improve the auditory experience of the listener; user interaction technologies, focused on mapping user-driven actions to changes in the auditory experience; and experiential technologies, focused on using technology to deliver new auditory experiences.

One NGA technology is Object-Based Audio, which consists of audio content together with metadata that tells the receiver device how to handle the audio. For example, in a traditional audio production process, many audio sources (e.g., microphones) are used to capture sound, and the audio sources can then be mixed down to a fewer number of channels which represent the final speaker layout, referred to as “downmixing”. For example, a hundred (100) microphones may be used to capture the sound played by an orchestra and then mixed down to two audio channels-one for “left” and one for “right” (to be reproduced by two loudspeakers in a stereo system). With Object-Based Audio, the sound sources can be grouped, or isolated, into audio feeds that constitute separate, logical audio objects. For example, the different audio feeds might correspond to different individual voices or instruments, different sound effects (e.g., like a passing vehicle). An audio feed for a group of microphones can make up a logical entity (e.g., a string section or a drum kit). Each feed is distributed as a separate object made of the audio and the metadata containing descriptive data describing the audio, such as the audio's spatial position, the audio level, and the like. The metadata can be modified by a user, allowing the user to control how that audio stream is reproduced.

Another example of NGA technology is Immersive Audio, which augments horizontal surround sound with the vertical dimension (i.e., height). Immersive audio formats may be encoded as either channel-based systems or soundscene-based systems. In the case of channel-based systems, a number of audio channels contain the audio signals, where each channel is assigned to a discrete physical loudspeaker in the reproduction setup. This is identical to how “non-immersive” channel-based audio formats (e.g., stereo, 5.1) are represented, the only difference being the number of channels available and the number of physical loudspeakers able to reproduce the sound field. Examples include 22.2 and 10.2 systems, as described in the ITU-R BS.2159-9.

Soundscene-based audio formats encode an acoustic sound field which can later be decoded to a specified loudspeaker array and/or headphone format. One soundscene-based method is Ambisonics, which encodes a sound field above and below the listener in addition to in the horizontal plane (e.g., front, back, left, and right). Ambisonics can be understood as a three-dimensional extension of mid/side stereo that adds additional channels for height and depth. Ambisonics is a technique storing and reproducing a sound field at a particular point with spatial accuracy. The degree of accuracy to which the sound field can be reproduced depends on multiple factors, such as the number of loudspeakers available at the reproduction stage, how much storage space is available, computing power, download/transmission limits, etc. Ambisonics involves encoding a sound field to create a set of signals, referred to as audio channels, that depends on the position of the sound, with the audio channels weighted (e.g., with different gains) depending on the position of the sound source. A decoder then decodes the audio channels to reproduce the sound field. Loudspeaker signals can be derived using a linear combination of the Ambisonic component signals.

As discussed herein, faithful reproduction of an audio signal relies on the user having a local reproduction system setup very similar to the setup that is used in the production stage of the audio. In general, the process of audio reproduction involves the mapping of a set of input audio signals with a target spatial position, relative to a reference point, to a set of output audio channels which are to be reproduced by a loudspeaker array comprising a number of real loudspeakers with their own spatial positions. As used herein, the target spatial position relative to the reference point may be referred to as the listening “sweetspot.” The sweetspot refers to the ideal listening position where the stereo image and spatial cues are most accurately reproduced, and represents the area between the loudspeakers where the listener experiences the best possible sound quality.

Where the target spatial positions of the input signals match the spatial positions of the real loudspeakers of the loudspeaker array, and the listener's position matches the reference position (is in the sweetspot), the audio can be reproduced by the loudspeakers with a high level of fidelity.

In some cases, however, the loudspeakers are incorrectly placed and/or the listener is not in an expected position (e.g., is not positioned at the reference point). In this case, there is an error between the target spatial positions of the audio and the real spatial positions of the loudspeakers in a local reproduction setup and/or there is an error in the relative speaker-listener location(s).

As used herein, incorrect loudspeaker positioning refers to loudspeaker positioning that generates an inaccurate or degraded sound image. In some examples, incorrect loudspeaker positioning may occur when the loudspeakers are positioned according to a non-standardized positioning, such as a loudspeaker placement that does not conform to the ITU-R recommended positioning (e.g., such as those specified in ITU-R 775). It is common in domestic setups that the user neglects (intentionally or unintentionally) to correctly calibrate and arrange the loudspeakers according to the relevant standards. In some aspects, the incorrect loudspeaker positioning is a loudspeaker positioning where the loudspeaker is either closer or further from a listener than a target (e.g., a configured, specified, or threshold) listener-loudspeaker separation distance. In some aspects, the target listener-loudspeaker separation distance is an absolute value. In some aspects, the incorrect loudspeaker positioning is a loudspeaker positioning where the loudspeaker is either closer or further from a listener than another loudspeaker (e.g., the loudspeakers have different relative listener-loudspeaker separation distances).

As used herein, incorrect listener positioning refers to listener positioning relative to loudspeaker positions or listener positioning relative to a reference user positioning that results in an inaccurate or degraded sound image perceived by the listener. In some examples, incorrect listener positioning may occur when the listener is positioned according to a non-standardized positioning, such as a listener position that does not conform to the ITU-R recommended reference position (e.g., such as those specified in ITU-R 775). It is common in domestic setups that the user neglects positioning them self (intentionally or unintentionally) correctly according to the relevant standards. In some aspects, the incorrect listener positioning is a listener positioning where the listener is either closer or further from a loudspeaker than a target (e.g., a configured, specified, or threshold) listener-loudspeaker separation distance. In some aspects, the incorrect listener positioning is a listener positioning where the listener is either closer or further from a loudspeaker than another loudspeaker (e.g., the listener and loudspeakers have different relative listener-loudspeaker separation distances).

Where the loudspeakers are incorrectly placed and/or where the listener is not located in the correct position, the listener may not perceive the audio experience as intended, thereby degrading the listening experience.

Accordingly, it may be appropriate to consider techniques and apparatus for improving the user experience where the relative loudspeaker and user positions are incorrect.

### SUMMARY

Particular aspects are set out in the appended independent claims. Various optional embodiments are set out in the dependent claims.

The technology described herein provides a method of adaptive loudspeaker and listener positioning compensation.

A method of audio reproduction is provided. The method includes obtaining an audio signal. The audio signal is associated with one or more audio channels and each audio channel is associated with a position of an audio source with respect to a reference point within a local reproduction system. The method includes determining dynamic position information. The dynamic position information includes positions of one or more loudspeakers within the local reproduction system relative to the reference point, a position of a listener relative to the reference point, positions of the one or more loudspeakers relative to the listener, or a combination thereof. The method includes automatically applying one or more adaptive sweetspot parameters to the audio signal based on the dynamic position information. The method includes automatically controlling a directivity of the one or more loudspeakers based on the dynamic position information and the one or more adaptive sweetspot parameters. The method includes rendering the corrected audio signal to the local reproduction system based on the directivity of the one or more loudspeakers and the adaptive sweetspot parameters.

A system for audio reproduction is provided. The system includes a local reproduction system including one or more loudspeakers. The system includes a location sensor configured to collect raw position data. The raw position data includes positions of one or more loudspeakers, a position of a listener relative to the reference point, positions of the one or more loudspeakers relative to the listener, or a combination thereof. The system includes one or more control units. The one or more control units are configured to obtain an audio signal. The audio signal is associated with one or more audio channels. Each audio channel is associated with a position of an audio source with respect to a reference point within the local reproduction system. The one or more control units are configured to determine dynamic position information from the raw position data. The dynamic position information includes positions of one or more loudspeakers within the local reproduction system relative to the reference point, a position of a listener relative to the reference point, positions of the one or more loudspeakers relative to the listener, or a combination thereof. The one or more control units are configured to automatically apply one or more adaptive sweetspot parameters to the audio signal based on the dynamic position information. The one or more control units are configured to automatically control a directivity of the one or more loudspeakers based on the dynamic position information and the one or more adaptive sweetspot parameters. The system includes a renderer configured to render the audio signal to the local reproduction system based on the directivity of the one or more loudspeakers and the adaptive sweetspot parameters.

A computer readable medium comprising (e.g. storing and/or conveying) computer executable code for audio reproduction is provided. The computer executable code includes code for obtaining an audio signal. The audio signal is associated with one or more audio channels. Each audio channel is associated with a position of an audio source with respect to a reference point within a local reproduction system. The computer executable code includes code for determining dynamic position information. The dynamic position information includes positions of one or more loudspeakers within the local reproduction system relative to the reference point, a position of a listener relative to the reference point, positions of the one or more loudspeakers relative to the listener, or a combination thereof. The computer executable code includes code for automatically applying one or more adaptive sweetspot parameters to the audio signal based on the dynamic position information. The computer executable code includes code for automatically controlling a directivity of the one or more loudspeakers based on the dynamic position information and the one or more adaptive sweetspot parameters. The computer executable code includes code for rendering the corrected audio signal to the local reproduction system based on the directivity of the one or more loudspeakers and the adaptive sweetspot parameters.

A loudspeaker is provided. The loudspeaker includes a memory. The loudspeaker includes one or more processors. The one or more processors are configured to obtain an audio signal. The audio signal is associated with one or more audio channels. Each audio channel is associated with a position of an audio source with respect to a reference point within the local reproduction system. The one or more processors are configured to determine dynamic position information. The dynamic position information includes a position of the loudspeaker within the local reproduction system relative to the reference point, a position of a listener relative to the reference point, a position of the loudspeaker relative to the listener, or a combination thereof. The one or more processors are configured to automatically apply one or more adaptive sweetspot parameters to the audio signal based on the dynamic position information. The one or more processors are configured to automatically control a directivity of the one or more loudspeakers based on the dynamic position information and the one or more adaptive sweetspot parameters. The one or more processors are configured to output the audio signal based on the directivity of the loudspeaker and the adaptive sweetspot parameters.

Another method of audio reproduction is provided. The method includes obtaining an audio signal. The audio signal is associated with one or more audio channels and each audio channel is associated with a position of an audio source with respect to a reference point within a local reproduction system. The method includes determining dynamic position information, wherein the dynamic position information includes positions of one or more loudspeakers within the local reproduction system relative to the reference point, a position of a listener relative to the reference point, positions of the one or more loudspeakers relative to the listener, or a combination thereof. The method includes determining a directivity of one or more loudspeakers within the local reproduction system based on the dynamic position information. The method includes automatically enabling or disabling an adaptive sweetspot function based on the directivity of the one or more loudspeakers. The method includes rendering the one or more audio signals to the one or more loudspeakers based on the directivity of the one or more loudspeakers.

A system for audio reproduction is provided. The system includes a local reproduction system including one or more loudspeakers. The system includes a location sensor configured to collect raw position data. The raw position data includes positions of one or more loudspeakers, a position of a listener relative to a reference point in the system, positions of the one or more loudspeakers relative to the listener, or a combination thereof. The system includes one or more control units. The one or more control units are configured to obtain an audio signal. The audio signal is associated with one or more audio channels. Each audio channel is associated with a position of an audio source with respect to a reference point within the local reproduction system. The one or more control units are configured to determine dynamic position information from the raw position data. The dynamic position information includes positions of one or more loudspeakers within the local reproduction system relative to the reference point, a position of a listener relative to the reference point, positions of the one or more loudspeakers relative to the listener, or a combination thereof. The one or more control units are configured to determine a directivity of one or more loudspeakers within the local reproduction system based on the dynamic position information. The one or more control units are configured to automatically enable or disable an adaptive sweetspot function based on the directivity of the one or more loudspeakers. The system includes a renderer configured to render the one or more audio signals to the one or more loudspeakers based on the directivity of the one or more loudspeakers.

A computer readable medium is provided. The computer readable medium includes computer executable code for audio reproduction. The computer executable code includes code for obtaining an audio signal. The audio signal is associated with one or more audio channels. Each audio channel is associated with a position of an audio source with respect to a reference point within a local reproduction system. The computer executable code includes code for determining dynamic position information. The dynamic position information includes positions of one or more loudspeakers within the local reproduction system relative to the reference point, a position of a listener relative to the reference point, positions of the one or more loudspeakers relative to the listener, or a combination thereof. The computer executable code includes code for determining a directivity of one or more loudspeakers within the local reproduction system based on the dynamic position information. The computer executable code includes code for automatically enabling or disabling an adaptive sweetspot function based on the directivity of the one or more loudspeakers. The computer executable code includes code for rendering the one or more audio signals to the one or more loudspeakers based on the directivity of the one or more loudspeakers.

A loudspeaker is provided. The loudspeaker includes memory and one or more processors. The one or more processors are configured to obtain an audio signal. The audio signal is associated with one or more audio channels. Each audio channel is associated with a position of an audio source with respect to a reference point within a local reproduction system. The one or more processors are configured to determine dynamic position information. The dynamic position information includes a position of the loudspeaker within the local reproduction system relative to the reference point, a position of a listener relative to the reference point, a position of the loudspeaker relative to the listener, or a combination thereof. The one or more processors are configured to determine a directivity of the loudspeaker within the local reproduction system based on the dynamic position information. The one or more processors are configured to automatically enable or disable an adaptive sweetspot function based on the directivity of the loudspeaker. The one or more processors are configured to output the one or more audio signals based on the directivity of the loudspeaker.

Other aspects provide: an apparatus operable, configured, or otherwise adapted to perform any one or more of the aforementioned methods and/or those described elsewhere herein; a computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 depicts a diagram of an example multimedia system and sound field, according to one or more aspects.

FIG. 2 depicts an example local reproduction setup in the multimedia system of FIG. 1, according to one or more aspects.

FIG. 3 depicts a block diagram of a target sound field in a multimedia system with correct loudspeaker and listener positioning, according to one or more aspects.

FIG. 4 depicts an example of a sound field in the multimedia system of FIG. 3 with incorrect loudspeaker positioning, according to one or more aspects.

FIG. 5 depicts an example of a sound field in the multimedia system of FIG. 3 with incorrect listener positioning, according to one or more aspects.

FIG. 6 depicts an example of adaptive sweetspot compensation in the multimedia system of FIG. 5 with the incorrect listener positioning, according to one or more aspects.

FIG. 7 depicts an example workflow for adaptive sweetspot compensation, according to one or more aspects.

FIG. 8 illustrates example directivity control for a pair of loudspeakers.

FIG. 9 illustrates an example plot of loudspeaker directivity control based on listener distance from a reference location.

FIG. 10 illustrates an example plot of adaptive sweetspot function state based on loudspeaker directivity.

FIG. 11 depicts an example flow diagram for control of loudspeaker directivity as a function of listener distance from a reference point, according to one or more aspects.

FIG. 12 depicts an example flow diagram for adaptive sweetspot compensation state as a function of loudspeaker directivity, according to one or more aspects.

FIG. 13 depicts an example device for adaptive sweetspot compensation and dynamic control of loudspeaker directivity according to one or more aspects.

### DETAILED DESCRIPTION

The present disclosure provides an approach for adaptive control of loudspeaker directivity and adaptive sweetspot compensation.

In some aspects, positional data of one or more loudspeakers within a local reproduction setup, positional data of a listener, or both, are dynamically collected. Some examples of sensor technologies used for collection of dynamic positional data includes ultra wideband (UWB), Bluetooth, and ultrasound. In some examples, real-time positional data is collected (e.g., continuously, periodically, responsive to a trigger, or on-demand). In some aspects, a time constant is applied to the collected raw loudspeaker and/or listener positioning data to smooth the raw data. In some aspects, the raw positioning data is positioning data of the loudspeakers relative to a reference point, relative to another loudspeaker, or relative to the listener. In some aspects, the raw positioning data is positioning data of the listener relative to a reference point or relative to one or more loudspeakers. In some aspects, the listener and/or loudspeaker positions are dynamically determined as Cartesian coordinates (e.g., x- and y-coordinates or x-, y-, and z-coordinates) or as spherical coordinates (e.g., Azimuth (degrees), Elevation (degrees) and Distance (meters)).

In some aspects, the positional data is used to adaptively correct the sound field generated by the one or more loudspeakers to compensate for incorrect loudspeaker and/or listener positioning. As discussed in more detail herein, dynamic positional data may be used for control of loudspeaker directivity and for adaptive sweetspot compensation.

As discussed in more detail herein, an audio reproduction system may support both control of loudspeaker directivity and adaptive sweetspot compensation functions to compensate for incorrect loudspeaker and/or listener positioning. However, in systems where both loudspeaker directivity and adaptive sweetspot compensation functions are used, the loudspeaker directivity and adaptive sweetspot compensation functions may operate independently of each other, which may lead to conflicts that degrade the listener experience.

Accordingly, aspects of the present disclosure provide techniques, apparatus, and systems for resolving or avoiding such conflicts in systems that support both loudspeaker directivity and adaptive sweetspot compensation.

According to certain aspects, the loudspeaker directivity may be controlled as a function of the listener position with respect to the sweetspot. In some aspects, the sweetspot is the effective sweetspot as adapted by the adaptive sweetspot compensation function. Thus, the loudspeaker directivity may account for the adaptive sweetspot compensation by controlling the loudspeaker directivity as a function of the listener position with respect to the effective (adaptive) sweetspot location. In some aspects, the loudspeaker directivity may be controlled automatically or autonomously by the system (e.g., without requiring user input for the control).

According to certain aspects, the adaptive sweetspot compensation may account for the loudspeaker directivity. For example, the adaptive sweetspot compensation function may be enabled or disabled based on a level of the loudspeaker directivity. In some aspects, one or more thresholds may be specified or preconfigured for enabling and disabling the adaptive sweetspot compensation function. In some aspects, the enabling and disabling of the adaptive sweetspot compensation, as well as the adaptive sweetspot compensation itself when enabled, may be controlled automatically or autonomously by the system (e.g., without requiring user input for the control).

Thus, aspects of the present disclosure may avoid conflicts in systems using both loudspeaker directivity and adaptive sweetspot compensation, which may improve the listener experience across the full spectrum of loudspeaker settings. In addition, because the techniques may be automated, reduced user input is required, which may further improve the user experience.

### Example Audio Reproduction System

In some cases, a user consumes both audio content and associated visual content. Audio content or audio-visual content may be provided by a multimedia system. While aspects of the disclosure are described with respect to a multimedia system, it should be understood that the aspects described herein equally apply to any local reproduction setup.

A multimedia system generally includes a visual display and acoustic transducers. Multimedia installations typically include a display screen, loudspeakers, and a control unit for providing input to the display screen and to the loudspeakers. The input may be a signal from a television provider, a radio provider, a gaming console, various Internet streaming platforms, and the like. It should be understood that other components may also be included in a multimedia installation.

Both audio and visual systems have the option to be tethered, or not, to the user. As used herein, “tethered” refers to whether the audio-visual content moves relative to the user when the user moves. For example, headphones worn by a user which do not apply dynamic head-tracking processing provide a “tethered” audio system, where the audio does not change relative to the user. As the user moves about, the user continues to experience the audio in the same way. On the other hand, loudspeakers placed in a room may be “untethered” and do not move with the user. Similarly, a pair of headphones which employ dynamic head-tracked binaural rendering would be considered a form of “untethered”, albeit one that is simulated. Thus, as the user moves about, the user may experience the audio content differently. Similarly, a television mounted to a wall is an example of an untethered visual system, whereas a screen (e.g., a tablet or phone) held by the user is an example of a tethered visual system. A virtual reality (VR) headset may provide a form of simulated “untethered” video content, in which the user experiences the video content differently as the user moves about. It should be understood that these examples are merely illustrative, and other devices may provide tethered and untethered audio and visual content to a user.

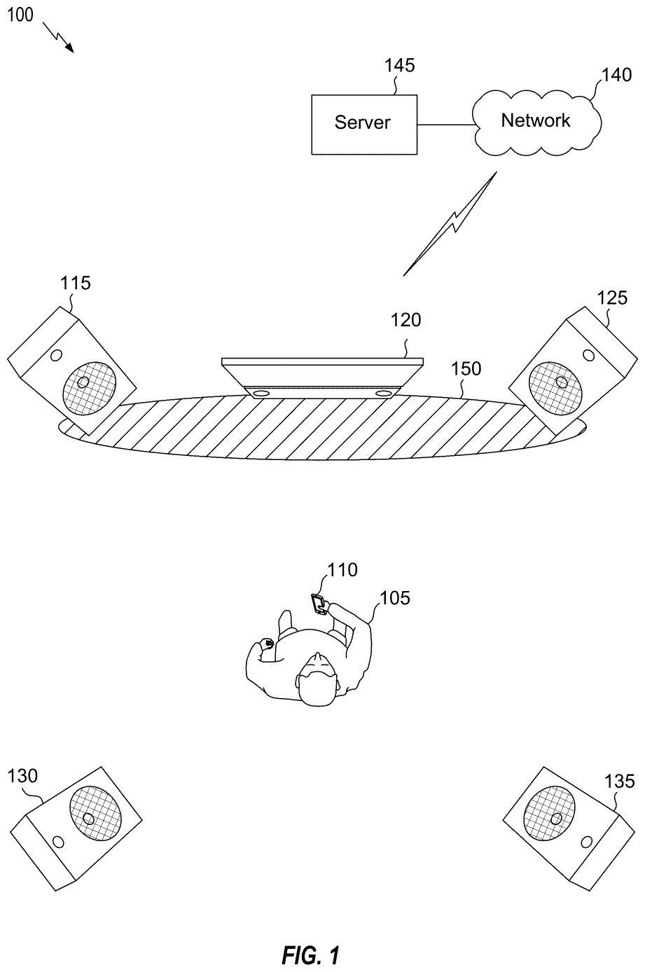

FIG. 1 depicts example multimedia system 100 in which aspects of the present disclosure may be implemented. Multimedia system 100 may be located in any environment, such as in a home (e.g., in a living room or home theater), a yard, a theater, in a vehicle, in an indoor or outdoor venue, or any other suitable location.

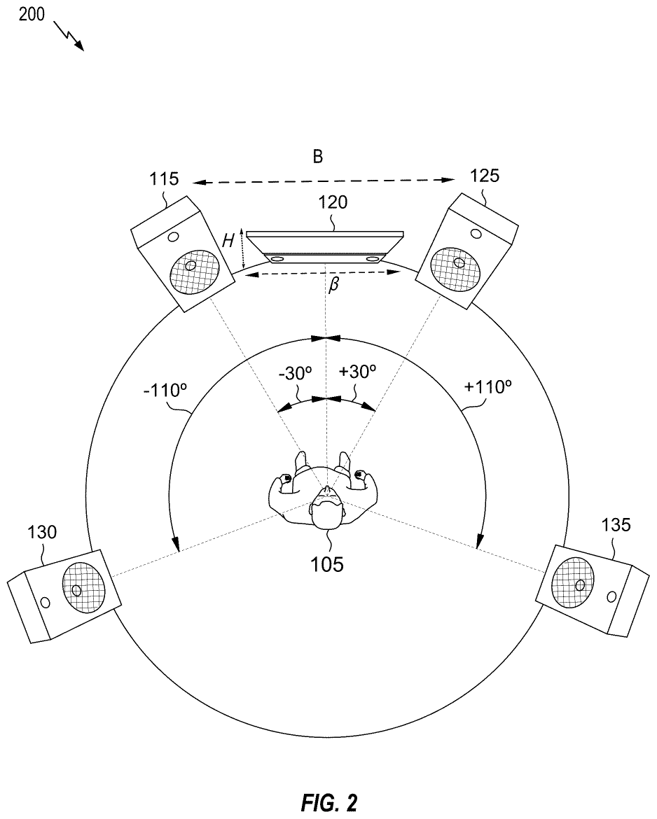

As shown, multimedia system 100 may include loudspeakers 115, 120, 125, 130, and 135. Loudspeakers 115, 120, 125, 130, and 135 may be any electroacoustic transducer device capable of converting an electrical audio signal into a corresponding sound. Loudspeakers 115, 120, 125, 130, and 135 may include one or more speaker drivers, subwoofers drivers, woofer drivers, mid-range drivers, tweeter drivers, coaxial drivers, and amplifiers which may be mounted in a speaker enclosure. Loudspeakers 115, 120, 125, 130, and 135 may be wired or wireless. Loudspeakers 115, 120, 125, 130, and 135 may be installed in fixed positions or moveable. Loudspeakers 115, 120, 125, 130, and 135 may be any type of speakers, such as surround-sound speakers, satellite speakers, tower or floor-standing speakers, bookshelf speakers, sound bars, TV speakers, in-wall speakers, smart speakers, portable speakers. It should be understood that while five loudspeakers are shown in FIG. 1, multimedia system 100 may include fewer or greater number of loudspeakers which may be positioned in multiple different configurations, as discussed in more detail below with respect to FIG. 2.

Multimedia system 100 may include one or more video displays. For example, a video display may be a user device, such as a smartphone or tablet 110 as shown in FIG. 1. It should be understood that a video display may be any type of video display device, such as a TV, a computer monitor, a smart phone, a laptop, a projector, a VR headset, or other video display device.

Although not shown in FIG. 1, multimedia system 100 may include an input controller. The input controller may be configured to receive an audio/visual signal and provide the visual content to a display (e.g., tablet 110 or TV 120) and audio content to the loudspeakers 115, 120, 125, 130, and 135. In some systems, separate input controllers may be used for the visual and for the audio. In some systems, the input controller may be integrated in one or more of the loudspeakers 115, 120, 125, 130, and 135 or integrated in the display device. In some systems, the input controller may be a separate device, such as a set top box (e.g., an audio/video receiver device).

In some aspects, one or more components of the multimedia system 100 may have wired or wireless connections between them. Wireless connections between components of the multimedia system 100 may be provided via a short-range wireless communication technology, such as Bluetooth, WiFi, ZigBee, ultra wideband (UWB), or infrared. Wired connections between components of the multimedia system 100 may be via auxiliary audio cable, universal serial bus (USB), high-definition multimedia interface (HDMI), video graphics array (VGA), or any other suitable wired connection.

In addition, multimedia system 100 may have a wired or wireless connection to an outside network 140, such as a wide area network (WAN). Multimedia system 100 may connect to the Internet via an Ethernet cable, WiFi, cellular, broadband, or other connection to a network. In some aspects, network 140 further connects to a server 145. In some aspects, the input controller may be integrated in the server 145.

Although not shown in FIG. 1, multimedia system 100 may include a renderer. In some aspects, the renderer may be implemented on the input controller. In some aspects, one or more renderers may be implemented in a receiver or decoder (which itself may be implemented in the input controller). The renderer is the component where the audio and its associated metadata are combined to produce the signal that will feed the loudspeakers of the local reproduction setup.

In the case that the local reproduction setup conforms to a known standard layout (e.g., as defined in ITU-R 775.3), the renderer may be pre-programmed with the standard layouts. The renderer is able to map the audio signals to the output loudspeaker signals. In the case that an unknown local reproduction setup is used, the render is provided with information about the local reproduction setup with information, such as (i) the number of loudspeakers and (ii) the positions (e.g., angle and/or distance) of the loudspeakers relative to a reference position.

Although not shown in FIG. 1, multimedia system 100 may include a decoder. In some aspects, the decoder may be implemented with the renderer. In some aspects, the decoder may be implemented on the input controller. The decoder is the component that decodes an audio signal and its associated metadata.

A listener 105 may interact with the multimedia system 100. For example, the listener 105 may consume audio/visual content output by the multimedia system 100. In the example shown in FIG. 1, the listener 105 may listen to sound from the loudspeakers 115, 120, 125, 130, and 135 and may view video on the tablet 110. In some aspects, the listener 105 may also control the multimedia system 100. For example, the listener 105 may position loudspeakers 115, 120, 125, 130, and 135 and/or the video display(s) within the multimedia system 100, and the listener 105 may configure one or more settings of the multimedia system 100.

The number of loudspeakers (five, in the example illustrated in FIG. 1) and positions of loudspeakers within the multimedia system 100 may be referred to herein as the local reproduction setup. The sound output by the local reproduction setup creates what is referred to herein as a sound field 150 or sound image. The sound field 150 refers to the perceived spatial locations of the sound source(s), which may be laterally, vertically, and depth. A surround sound system that provides a good user experience offers good imaging all around the listener. The quality of the sound field arriving at the listener's ear may depend on both the original recording and the local reproduction setup.

Recommended loudspeaker positions are provided by the International Telecommunication Union (ITU) Radiocommunication Sector (ITU-R). For example, ITU-R BS.775-3 provides recommendations for Multichannel stereophonic sound systems with and without accompanying picture. In some aspects, a multimedia system 100 may be configured according to the ITU-R recommendations. In some aspects, a multimedia system 100 may not be configured according to the standard ITU-R recommendations, but may be configured at any positions desired by the user (e.g., due to area constraints within a room or environment).

FIG. 2 depicts an example local reproduction setup 200 in the multimedia system 100 of FIG. 1, according to one or more aspects. FIG. 2 illustrates local reproduction setup 200 with the five loudspeakers 115, 120, 125, 130, and 135 of example multimedia system 100, however, as discussed herein, different numbers of loudspeakers may be included in the multimedia system with different arrangements.

As shown, the example local reproduction setup 200 includes three front loudspeakers, 115, 120, and 125, combined with two rear/side loudspeakers 130 and 135. Optionally, there may be an even number of more than two rear-side loudspeakers which may provide a larger listening area and greater envelopment for the user. For example, a seven loudspeaker setup may provide two additional side loudspeakers in addition to the left-rear loudspeaker 130 and the right-rear loudspeaker 135.

In some aspects, center loudspeaker 120 may be integrated in a TV (e.g., a high-definition TV (HDTV)) or a soundbar positioned in-front of or below the TV. The left-front loudspeaker 115 and the right-front loudspeaker 125 are placed at extremities of an arc subtending 600 at the reference listening point. As shown in FIG. 2, the left-front loudspeaker 115 is positioned at −30°, where 0° is defined here as the line from the listener 105 to the center loudspeaker 120, and where the minus angle is defined in the left, or counter-clockwise, direction from the center line. As shown in FIG. 2, the right-front loudspeaker 125 is positioned at +300 from the center line, and where the positive angle is defined in the right, or clockwise, direction from the center line. The distance between the left-front loudspeaker 115 and the right-front loudspeaker 125 is referred to as the loudspeaker basewidth (B). Where the center loudspeaker 120 is integrated in a screen, the distance between the reference listening point (e.g., listener 105) and the screen is referred to as the reference distance and may depend on the height (H) and width (0) of the screen. In some aspects, the center and front loudspeakers, 115, 120, and 125 may be positioned at a height approximately equal to a sitting user (e.g., 1.2 meters).

As shown in FIG. 2, the left-rear loudspeaker 130 is positioned between −100° and −120°, e.g., at −110° as shown, and the right-rear loudspeaker 135 is positioned at between +100° and +120°, e.g., +1100 from the center line. In some aspects, the side/rear loudspeakers 130 and 135 may be positioned at a height equal or higher than the front loudspeakers and may have an inclination pointing downward. The side/rear loudspeakers 130 and 135 may be positioned no closer to the reference point than the front/center loudspeakers 115, 120, and 125.

In some aspects, for the example local reproduction setup 200, five audio channels may be used for front left (L), front right (R), center (C), left side/rear (LS), and right side/rear (RS). Additionally, a low frequency effects (LFE) channel may be included. The LFE channels may carry low frequency sound effects, this channel is indicated by the “0.1” in a “5.1” surround sound format.

Down-mixing (also referred to as downward mixing or downward conversion) or up-mixing (also referred to as upward conversion or upward mixing) can be performed to reduce or increase the number of channels to a desired number based on the number of delivered signals/channels and the number of available reproduction devices. Down-mixing involves mixing a higher number of signals/channels to a lower format with fewer channels, for example, for a local reproduction setup that does not have enough available loudspeakers to support the higher number of signals/channels. Up-mixing may be used when the local reproduction setup has a greater number of available loudspeakers supporting a higher number of signals/channels than the input number of signals/channels. Up-mixing involves generation of the “missing” channels. ITU-R provides example down-mixing equations and example up-mixing equations.

As mentioned above, while local reproduction setup 200 and multimedia system 100 depict five loudspeakers in an example arrangement, a local reproduction setup may include different numbers of loudspeakers in different arrangements. For example, ITU-R provides recommendations for multimedia systems with three, four, five, and seven loudspeakers for mono-channel systems, mono plus mono surround channel systems, two-channel stereo systems, two-channel stereo plus one surround channel systems, three-channel stereo systems, three-channel stereo plus one surround channels systems, and three-channel stereo plus two surround channels systems. Furthermore, as mentioned above, it should be understood that the local reproduction setup of a multimedia system may be configured in a non-standardized loudspeaker arrangement (e.g., configured with any arbitrary arrangement of two or more loudspeakers). In this case, information about the local reproduction setup (e.g., such as, number of loudspeakers, positions of loudspeakers relative to a reference point, etc.) is provided to the system.

With channel-based audio, the channels can be mixed according to a pre-established speaker layout (e.g., stereo, 5.1 surround, or any of the other systems discussed above) and are then distributed (e.g., streamed, stored in a file or DVD, etc.). In a studio, the recorded sounds pass through a panner that controls how much sound should be placed on each output channel. For example, for a 5.1 surround mix and a sound located somewhere between center and right, the panner will place a portion of the signal on the center and right channels, but not on the remaining channels. The outputs of the panners are mixed (e.g., using a bus) before distribution. That is, the left output of all panners is mixed and placed on the left channel, same for the right channel, and so on. During reproduction, each audio signal is sent to the loudspeaker corresponding to the audio signal. For example, the mixed audio signal for (L) is provided to the left-front loudspeaker, the mixed audio signal for (R) is provided to right-front loudspeaker, and so on.

For object-based audio, instead of mixing all sounds in the studio and distributing the final mix, all of the sounds can be independently distributed and then mixed during reproduction. Thus, like for channel-based audio, panners are used during recording to position the sound, but the panning information is not applied to mix the sound at this stage. Instead, metadata is used to indicate where the sounds should be positioned. The metadata is distributed along with the audio channels and during reproduction the panning information is actually applied to the sound based on the actual local reproduction setup. The panning information for a particular object may not be static but changing in time. The panning information may indicate the position of the sound, the size of the sound (e.g., the desired spread or number of loudspeakers for the sound), or other information. Each sound and its corresponding metadata is referred to as an “object.”

With object-based audio, the listener 105 can make choices about the configuration of the audio, which can be added to the mix, to optimize the user's experience. For example, the listener 105 can select the audio type (mono, stereo, surround, binaural, etc.), adjust particular audio signals (e.g., turn up the sound for dialogue, where dialogue is provided as an independent object), omit certain audio signals (e.g., turn off commentary on a sports game, where the commentary is provided as an independent object), select certain audio signals (e.g., select a language option for dialogue, where different languages for the dialogue are provided as independent objects), or other user preferences.

As mentioned above, the sounds output by the local reproduction setup produce the sound field 150 (or sound image). In a stereophonic sound reproduction setup including a left and a right loudspeaker (e.g., loudspeakers 115 and 125) radiating sound into a listening area in front of the loudspeakers, optimal stereophonic sound reproduction can be obtained in the symmetry plane between the two loudspeakers (as shown in FIG. 1). If substantially identical signals are provided to the two loudspeakers, a listener (e.g., listener 105) sitting in front of the loudspeakers in the symmetry plane will perceive a sound image in the symmetry plane between the loudspeakers. However, if the listener for instance moves to the right relative to the symmetry plane, the distance between the listener and the right loudspeaker will decrease and the distance between the listener and the left loudspeaker will increase, resulting in that the perceived sound image will move in the direction of the right loudspeaker, even though identical signals are still applied to the two loudspeakers. Similarly, if a loudspeaker is incorrectly positioned with respect to the listener, the separation distance between the listener and the loudspeaker will be incorrect resulting in a degraded sound image. Thus, generally, the perceived position of specific sound images in the total stereo image will depend on the position of the listener relative to the local loudspeaker setup. This effect is, however, not desirable as a stable stereophonic sound image is desired, i.e., a sound image in which the position in space of each specific detail of the sound image remains unchanged when the listener moves away from the intended sweetspot position.

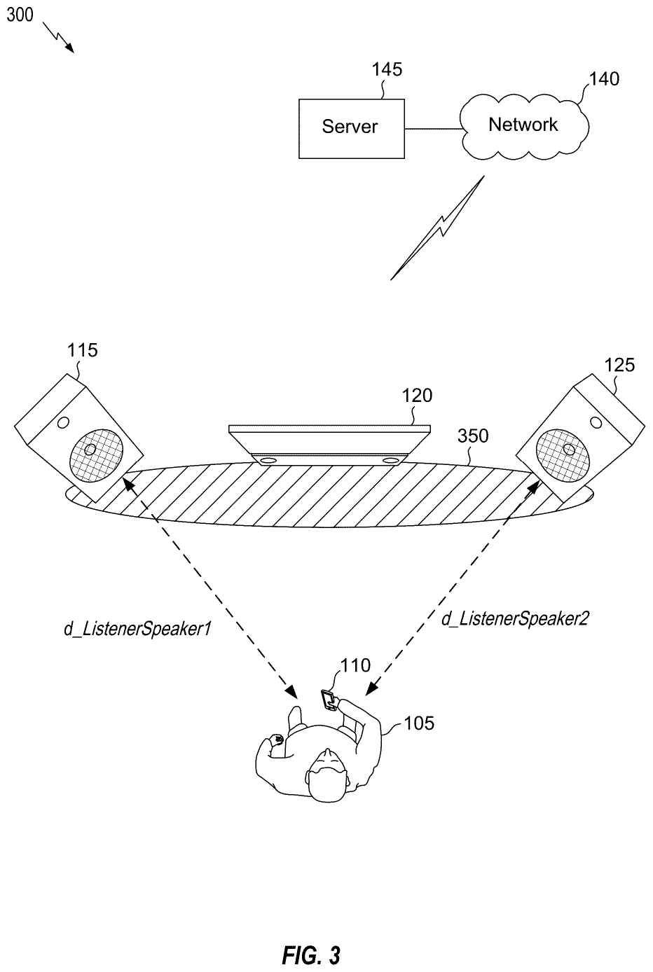

When the loudspeakers are placed with the correct amount of separation distance between the listener and the loudspeakers (i.e., all loudspeakers are equidistant from the listener and are at the correct apertures relative to the standard, such as ITU 775), a correct sound image is generated, resulting in a user experience that was intended by the producer. FIG. 3 depicts a block diagram of a target sound field 350 in a multimedia system 300 with correct positioning of the listener 105 and the loudspeakers 115 and 125, according to one or more aspects. As shown in FIG. 3, the loudspeakers 115 and 125 have a correct (or target) separation distance, where the distance of the listener 105 from the loudspeaker 115, d_{ListenerSpeaker1}, is equal to the distance of the listener 105 from the loudspeaker 125, d_{ListenerSpeaker2}, providing a sound field 350 with a desired sound image for the listener 105. It should be understood that the correct listener-loudspeaker separation distance, d_{correct}, may vary depending on the local reproduction setup, such as the size of the speakers and the distance of the speakers to a reference point (e.g., the listener 105 position) as well as the room acoustics.

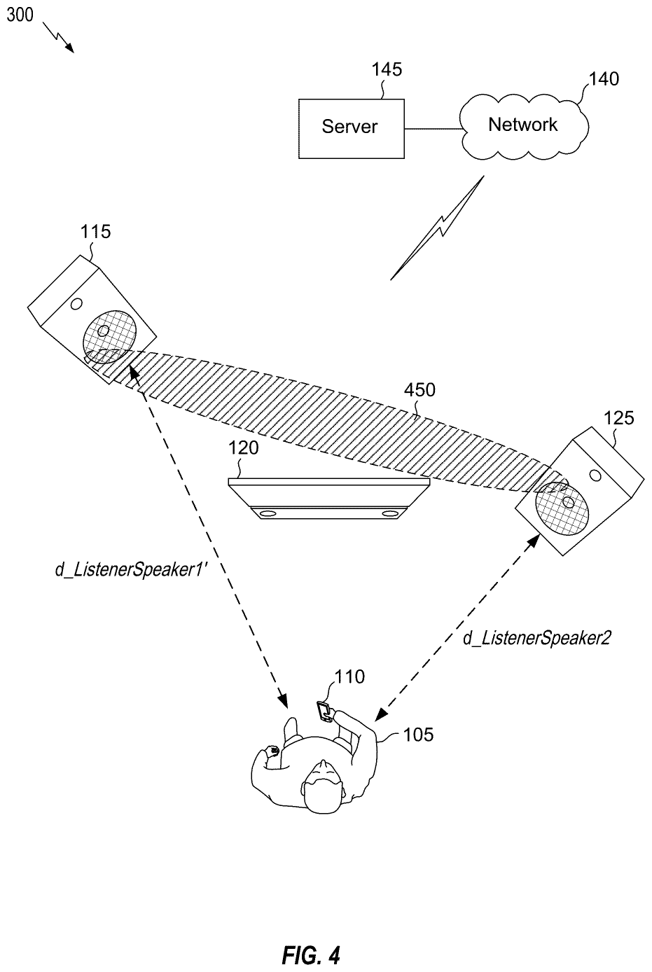

FIG. 4 depicts an example of a degraded sound field 450 in the multimedia system 300 of FIG. 3 with incorrect positioning of the listener 105 and loudspeakers 115 and 125, according to one or more aspects. As shown in FIG. 4, the loudspeaker 115 is positioned too far away from the listener 105 with a separation distance, d_{ListenerSpeaker1}′, between the listener 105 and the loudspeaker 115, where d_{ListenerSpeaker1}′>d_{ListenerSpeaker1} and d_{ListenerSpeaker1}′>d_{ListenerSpeaker2}. Accordingly, the sound field 450 does not match the desired sound field 350. The sound field 450 is shifted with respect to the sound field 350 with the desired sound image, with the front right loudspeaker 125 dominating, providing a poor sound image.

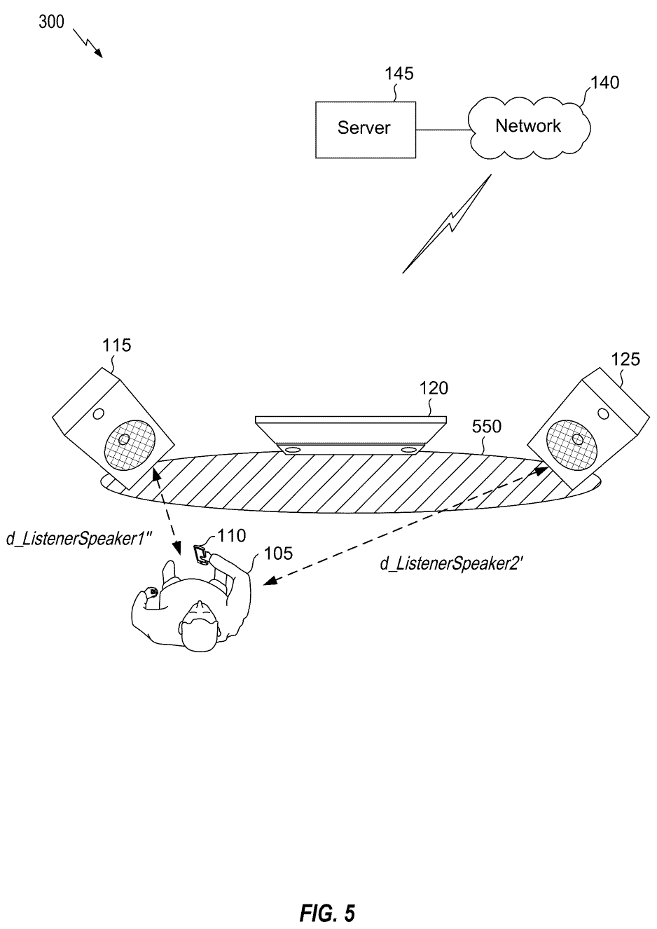

FIG. 5 depicts an example of an incorrectly positioned listener 105 with the loudspeakers 115 and 125 in the multimedia system 300 of FIG. 3, according to one or more aspects. As shown in FIG. 5, the listener 105 is positioned too closely to the loudspeaker 115, at d_{ListenerSpeaker1}″, and too far from the loudspeaker 125 at d_{ListenerSpeaker2}′, where d_{ListenerSpeaker1} d_{ListenerSpeaker1}, d_{ListenerSpeaker2}′>d_{ListenerSpeaker2}, and d_{ListenerSpeaker1}″<d_{ListenerSpeaker2}′. Accordingly, the listener 105 will not correctly perceive the desired sound image. The sound field 550 perceived by the listener 105 is shifted with respect to the sound field 350, with the front left loudspeaker 115 dominating, providing a poor sound image.

Accordingly, incorrect listener and loudspeaker positioning with an error in the listener-loudspeaker separation distance may cause distortion in the perceived audio by the listener and degrade the user's experience. The presently taught approaches can, in at least some implementations, provide for a loudspeaker setup that does not suffer from this disadvantageous effect of the incorrectly positioned listener and loudspeakers on the perceived sound image.

### Example Adaptive Sweetspot Compensation

Adaptive sweetspot compensation techniques may be used for compensating audio distortion associated with listener position. Adaptive sweetspot compensation may be achieved by applying gains and time delays to input audio signals to simulate a smaller or larger propagation length (i.e., listener-speaker distance). While examples of adaptive sweetspot compensation techniques are described herein, it should be understood that any adaptive sweetspot compensation technique may be used.

While aspects of the present disclosure are discussed with respect to two loudspeakers, the aspects described herein for adaptive sweetspot compensation may be performed for any pair of speakers in a local reproduction setup including any number of loudspeakers.

In some aspects, a target separation distance between a listener and the loudspeakers is specified. When the collected positional data indicates the listener-loudspeaker separation distance is smaller or larger than the target separation distance, the sound field can be adaptively corrected to compensate for the difference between the measured or computed listener-loudspeaker separation distance and the target separation distance. In some cases, the target separation distance may be defined based on the resolution and/or accuracy of the positioning technology used to detect the listener and/or loudspeaker positions. For example, a low target separation distance may be chosen if the positioning technology is extremely accurate and higher target separation distance may be chosen if the positioning technology is less accurate. In other cases, the target separation distance may be further based on perceptual thresholds at which a typical human may begin to hear degradations in the sound image. In some aspects, the relative listener-loudspeaker separation distance is measured directly or is computed based on the respective listener positioning data and loudspeaker positioning data.

Adaptively correcting the sound image includes applying one or more corrective time delays to an input audio signal. In some aspects, adaptively correcting the sound image further includes applying one or more corrective gains to the input audio signal. In some aspects, the corrections are applied to the audio signal before rendering the audio signal to a local reproduction system to compensate for the incorrect listener-loudspeaker positioning such that the sound field generated by the loudspeakers matches the target or desired sound image generated at the target listener-loudspeaker separation distance. In some aspects, the one or more corrective gains and/or the one or more corrective time delays to apply to the audio signal(s) to compensate for the incorrect listener-loudspeaker separation distance may be determined based on a function, a mapping, or a look-up table that associates different corrective gains and corrective time delays to difference values.

In some aspects, when the listener and loudspeakers are correctly positioned (e.g., as illustrated in the example in FIG. 3), with a target separation distance between them, the adaptive sweetspot compensation can be bypassed, as the user perceives the intended sound image. That is, a gain equal to 1 and time delay equal to 0 (meaning no correction is applied) may be applied to the input audio signals for each of the loudspeakers.

On the other hand, when the listener and/or loudspeakers are incorrectly positioned, with either a too large or too small listener-loudspeaker separation distance, the adaptive sound image correction system applies corrective time delays, and in some cases additionally applies corrective gains, to one or more of the input audio signal to compensate for the incorrect listener-loudspeaker positioning. According to certain aspects, a panning algorithm is dynamically controlled with dynamic positioning information input to the panning algorithm, where the dynamic positioning information includes spatial positions of the listener and the loudspeakers of the local reproduction system estimated from positioning data collected by local positioning sensors. The adaptive sound image correction system compensates for the incorrect listener-loudspeaker positioning, such that although the listener and loudspeakers are incorrectly positioned, too closely together or too far apart, the adaptively corrected sound field reproduced by the loudspeakers is perceived by the listener 105 with the correct intended sound image, providing an enhanced listening experience for the user.

Where the loudspeaker 115, the loudspeaker 125, or the listener 105 are incorrectly positioned, the adaptive sound image correction system can adaptively correct the sound image to produce the desired sound image.

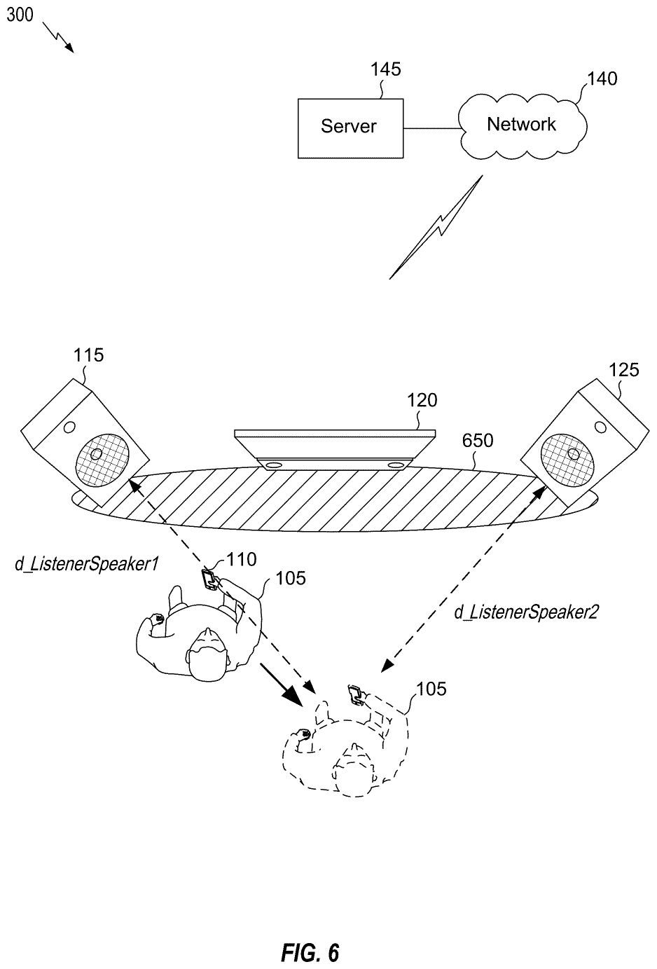

FIG. 6 depicts an example of an adaptively corrected sound field 650 in the multimedia system 300 of FIG. 5 with the listener 105 incorrectly positioned, according to one or more aspects. As shown in FIG. 6, by applying the adaptive sweetspot compensation for the incorrect positioning of the listener 105, the corrected sound field 650 is produced such that the listener 105 perceives the desired sound image as though the listener 105 were correctly positioned. For example, a first corrective gain g₁ and a first corrective time delay t₁ may be applied to the input audio signal for the loudspeaker 115, and a second corrective gain g₂ and a second corrective time delay t₂ may be applied to the input audio signal for the loudspeaker 125. The first corrective gain g₁ applied to the input audio signal for the loudspeaker 115 is smaller than the second corrective gain g₂ applied to the input audio signal for the loudspeaker 125, while the first corrective time delay t₁ applied to the input audio signal for the loudspeaker 115 is larger than the second corrective time delay t₂ applied to the input audio signal for the loudspeaker 125. The gain reduction and added delay to the input audio signal for the loudspeaker 115 simulates a longer propagation length, effectively placing the loudspeaker-listener distance at the correct distance (e.g., to effectively change the loudspeaker-listener distance d_{ListenerSpeaker1}″ to d_{ListenerSpeaker1}) as shown in FIG. 6. In addition, the gain and delay applied to the input audio signal for the loudspeaker 125 simulates a shorter propagation length, effectively placing the loudspeaker-listener distance at the correct distance (e.g., to effectively change the loudspeaker-listener distance d_{ListenerSpeaker2}′ to d_{ListenerSpeaker2}) as shown in FIG. 6.

In some aspects, adaptive sweetspot compensation may be applied to compensate for the incorrect positioning of a loudspeaker 115, for example to correct a scenario illustrated in the example in FIG. 4. For example, the system may apply a negative dB gain (e.g., to attenuate the audio signal) and a positive time delay to the audio signal sent to the closest loudspeaker 125 to align the time of arrival of the propagated acoustic wave with the farthest loudspeaker 115.

In some aspects, however, when a loudspeaker is positioned “too far” (e.g., further than a configured, specified, target, or threshold listener-loudspeaker separation distance), a two-phase sound image correction may be performed. The system may determine the listener-loudspeaker separation distances and, where the loudspeakers 115 and 125 are positioned incorrectly (e.g., as determined by the system based on the dynamic positioning information), the system applies a first dynamic gain and time delay to the loudspeaker 125 closest to the listener 105 to generate a corrected sound field. For example, the system applies a first negative dB gain and a first positive time delay to the loudspeaker 125 to effectively “move back” the loudspeaker 125 to match the listener-loudspeaker separation distance of the loudspeaker 115. In some aspects, the system applies first dynamic gains and time delays to all loudspeakers to match the listener-loudspeaker separation distance of the furthest loudspeaker. However, because in this example the loudspeaker 115 is positioned too far from the listener 105, the system then applies a second global gain (e.g., an equal positive gain applied to all loudspeakers within the local reproduction system), to effectively move the loudspeakers 115 and 125 closer to the listener to achieve the correct listener-loudspeaker separation distance.

In some aspects, the two-phase sound image correction may first apply a positive global time delay to all of the loudspeakers in the local reproduction system. The global time delay may be determined based on the listener-loudspeaker separation distance of the nearest loudspeaker to the listener. Then, a negative time delay may be applied to the loudspeakers further from the listener to effectively move the loudspeakers closer to the listener.

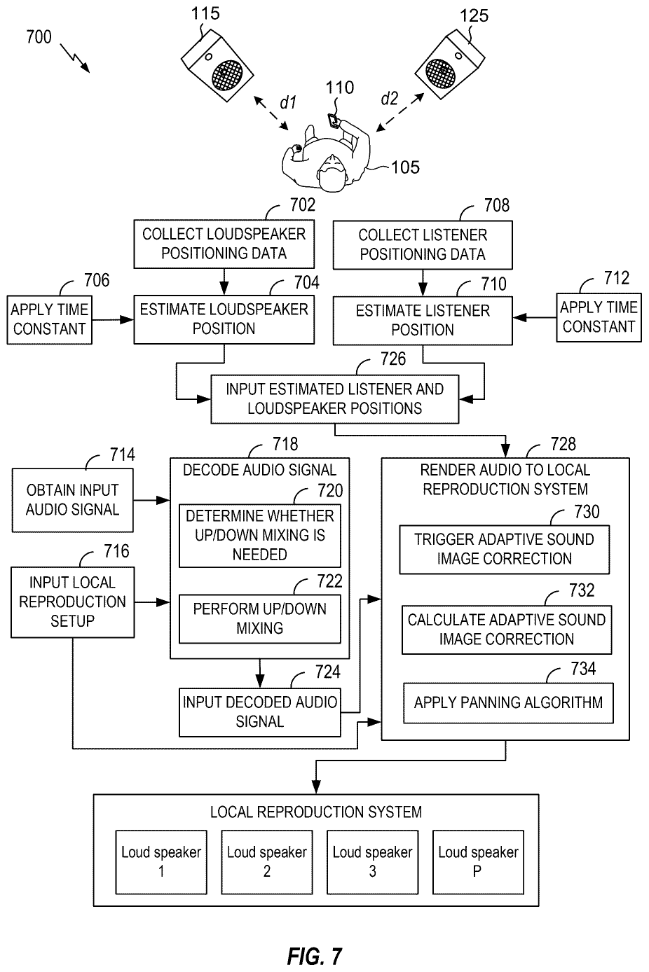

FIG. 7 depicts an example workflow 700 for adaptive sound image correction, according to one or more aspects. As shown in FIG. 7, the listener 105 has a first separation distance, d1, from the loudspeaker 115 and a second separation distance, d2, from the loudspeaker 125. While FIG. 7 is discussed with respect to listener 105 and loudspeakers 115 and 125, it should be understood that the aspects herein may be performed for any number of listeners in a local reproduction system with any number of loudspeakers.

At 702, loudspeaker positioning data is dynamically collected. The loudspeaker positioning data may include position information of the loudspeakers 115 and 125. In some aspects, the dynamic loudspeaker positioning data is collected continuously by one or more local sensors. In some aspects, the dynamic loudspeaker positioning data collection is triggered, such as by motion detection.

At 704, loudspeaker spatial positions are estimated based on the raw dynamic loudspeaker positioning data. In some aspects, the loudspeaker spatial positions are estimated in real-time (e.g., continuously or whenever the dynamic loudspeaker positioning data is received). In some aspects, the loudspeaker spatial position estimation is triggered, such as by a motion detection. In some aspects, a time constant is applied, at 706, to smooth the raw sensor data to reduce the sensitivity of the system. For example, the time constant may be used to filter out loudspeaker position data that occurs for a time duration smaller than the time constant threshold.

In some aspects, the loudspeaker position data is processed to produce spatial information, such as Cartesian coordinates (e.g., x- and y-coordinates or x-, y-, and z-coordinates) or spherical coordinates (e.g., Azimuth (in degrees) and distance (in meters) or Azimuth (in degrees), distance (in meters), and elevation (in degrees)) of the loudspeakers. The Cartesian or spherical system may be defined around a reference point, such as a target loudspeaker position, a target listener position, or other reference point. In some aspects, the loudspeaker spatial positions are represented as a P-element array of the Cartesian or spherical coordinates, where P is the number of physical loudspeakers in the local reproduction setup.

In some aspects, the collection of the dynamic raw loudspeaker position data and the processing of the dynamic raw loudspeaker position data, at 702-706, may be performed at a single integrated device or across multiple devices. In some aspects, the device or system that collects and processes the dynamic raw loudspeaker position data is implemented on another device within the system. For example, the dynamic raw loudspeaker position data collection and processing may be implemented on a loudspeaker (e.g., one or multiple of the loudspeakers 115 and 125) within the local reproduction system (e.g., multimedia system 100) or implemented on a control unit within the system. In some aspects, the dynamic raw loudspeaker position data collection and processing may be implemented on a separate stand-alone device within the system. In some aspects, the dynamic raw loudspeaker position data processing could be performed outside of the system, such as by a remote server (e.g., server 145).

At 708, listener positioning data is dynamically collected. The listener positioning data may include position information of the listener 105. In some aspects, the dynamic listener positioning data is collected continuously by one or more local sensors. In some aspects, the dynamic listener positioning data collection is triggered, such as by motion detection. In some aspects, the dynamic listener positioning data is collected using local sensor technologies such as UWB, Bluetooth, ultrasound, or other positioning technologies.

At 710, listener spatial positions are estimated based on the raw dynamic listener positioning data. In some aspects, the listener spatial position is estimated in real-time (e.g., continuously or whenever the dynamic listener positioning data is received). In some aspects, the listener spatial position estimation is triggered, such as by a motion detection. In some aspects, a time constant is applied, at 712, to smooth the raw sensor data to reduce the sensitivity of the system. For example, the time constant may be used to filter out listener position data that occurs for a time duration smaller than the time constant threshold.

In some aspects, the listener position data is processed to produce spatial information, such as Cartesian coordinates (e.g., x- and y-coordinates or x-, y-, and z-coordinates) or spherical coordinates (e.g., Azimuth (in degrees) and distance (in meters) or Azimuth (in degrees), distance (in meters), and elevation (in degrees)) of the loudspeakers. The Cartesian or spherical system may be defined around a reference point, such as a target loudspeaker position, a target listener position, or other reference point. In some aspects, the listener spatial positions are represented as a 1-element array of the Cartesian or spherical coordinates.

In some aspects, the collection of the dynamic raw listener position data and the processing of the dynamic raw listener position data, at 708-712, may be performed at a single integrated device or across multiple devices. In some aspects, the device or system that collects and processes the dynamic raw listener position data is implemented on another device within the system. For example, the dynamic raw listener position data collection and processing may be implemented on a loudspeaker (e.g., one or multiple of the loudspeakers 115 and 125) within the local reproduction system (e.g., multimedia system 100) or implemented on a control unit within the system. In some aspects, the dynamic raw listener position data collection and processing may be implemented on a separate stand-alone device within the system. In some aspects, the dynamic raw listener position data processing could be performed outside of the system, such as by a remote server (e.g., server 145).

The collection and processing of the raw dynamic loudspeaker positioning data, at 702-706, and the raw dynamic listener positioning data, at 708-712, may be performed at different times or at the same time. The collection and processing of the raw dynamic loudspeaker positioning data, at 702-706, and the raw dynamic listener positioning data, at 708-712, may be performed by the same sensors and devices or by different sensors and devices. In some aspects, raw separation distance data between the listener and the loudspeakers is dynamically collected and processed.

At 714, the system obtains an input audio signal. The audio signal may be a channel-based audio signal or an object-based audio signal. The input audio signal is associated with target loudspeaker positions for the decoded audio signals. For object-based audio, the target loudspeaker positions are represented as a separate stream of data with time-varying positional data that informs any downstream renderers where each audio stream should be positioned in space. For channel-based audio, the target loudspeakers may be encoded in the audio signal and metadata may be provided by the decoder output or derived from the number of decoded audio channels.

At 716, local reproduction setup information is input to a decoder. The local reproduction setup information may include the number of available loudspeakers in the local reproduction system, positions (e.g., angle and/or distance) of the loudspeakers relative to a reference point, and/or capabilities of the loudspeaker. The capabilities of the loudspeakers may include a frequency response, a minimum output level, a maximum output level, and/or a sensitivity of the loudspeakers.

At 718, the input audio signal is decoded. In some aspects, the input audio signal is decoded based on the local reproduction setup information. For example, the system may determine how many output audio channel to decode. At 720, the system may determine whether upmixing or downmixing is needed based on the number of audio channels and the number of available loudspeakers within the local reproduction system. At 722, the system performs upmixing or downmixing on the audio signal based on the determination at 720. For an N-channel input audio signal, the decoder outputs an M channel audio signal, where M may be equal to (in the case of no upmixing or downmixing), larger than (in the case of upmixing), or smaller than N (in the case of downmixing). Where upmixing or downmixing is performed, the target spatial locations associated with the audio signal may be updated. The decoder may provide metadata with the target spatial locations or the updated target spatial locations with the output audio signal.

In some aspects, the decoding, at 718-722, may be performed at a single integrated device or across multiple devices. In some aspects, the device or system that decodes the input audio signal is implemented on another device within the system. For example, the decoding may be implemented on a loudspeaker (e.g., one or multiple of the loudspeakers 115 and 125) within the local reproduction system (e.g., multimedia system 100) or implemented on a control unit within the system. In some aspects, the decoding may be implemented on a separate stand-alone device within the system. In some aspects, the decoding may be performed outside of the system, such as by a remote server (e.g., server 145).

At 724, the decoded audio signal is input to a local reproduction system renderer. As shown in FIG. 7, the local reproduction setup information, at 716, is also provided to the local reproduction system renderer. In addition, at 726, the estimated listener and loudspeaker positions are input to the local reproduction system renderer. In some aspects, the estimated listener and loudspeaker positions are input to the local reproduction system renderer in real-time (e.g., immediately after being estimated at 704 and 710). In some aspects, the estimated listener and loudspeaker positions are input to the local reproduction system renderer upon a trigger (e.g., when the decoded audio signal is input to the renderer). In this case, the estimated listener and loudspeaker positions may be stored in memory until triggered to input to the local reproduction system renderer.

At 728, the decoded audio signal is rendered to the local reproduction system (e.g., to the loudspeakers 1 . . . P). The local reproduction system renderer renders the audio to the physical loudspeakers in the local reproduction system based on the estimated loudspeaker positions, the estimated listener positions, the target loudspeaker positions, and the local reproduction setup information. For example, at 734, the local reproduction system renderer applies a panning algorithm to map M input audio signals with corresponding target spatial positions to P output audio signals to be reproduced by the P loudspeakers at the estimated spatial positions.

As shown in FIG. 7, the rendering may further include the adaptive sound image correction. At 730, the system may determine whether adaptive sound image correction is needed. For example, the system may determine whether adaptive sound image correction is needed based on the estimated listener and loudspeaker positions. In some aspects, the system determines adaptive sound image correction is not needed where the listener and loudspeakers are correctly positioned and determines the adaptive sound image correction is needed where listener and/or one or more loudspeakers are incorrectly positioned.

At 732, the system calculates the adaptive sound image correction. For example, the system may compute a delay and/or a gain to be applied to any of the P output channels to any of the P loudspeakers. The delay and/or the gain may be computed to correct for the incorrect listener and/or loudspeaker positioning. For example, the delay and/or the gain may be computed to compensate for the listener-loudspeaker separation distance, such that the sound field generated by the P loudspeakers matches, or attempts to match as closely possible, to a target or desired listener-loudspeaker separation distance. The computed gains and/or delays may then be applied to the respective audio signals.

In some aspects, the rendering, at 728-734, may be performed at a single integrated device or across multiple devices. In some aspects, the device or system that renders the decoded audio signal is implemented on another device within the system. For example, the rendering may be implemented on a loudspeaker (e.g., one or multiple of the loudspeakers 115 and 125) within the local reproduction system (e.g., multimedia system 100) or implemented on a control unit within the system. In some aspects, the rendering may be implemented on a separate stand-alone device within the system. In some aspects, the rendering may be performed outside of the system, such as by a remote server (e.g., server 145).

### Example Control of Loudspeaker Directivity

As discussed above, adaptive sweetspot techniques aim to adapt the sweetspot to the location of a particular listener. Techniques for controlling the loudspeaker directivity, on the other hand, may seek to adapt the audio directivity pattern to a larger listening area to account for multiple listeners. Directivity refers to the ability to shape, steer, or control the dispersion of sound waves emitted by a loudspeaker or an array of loudspeakers.

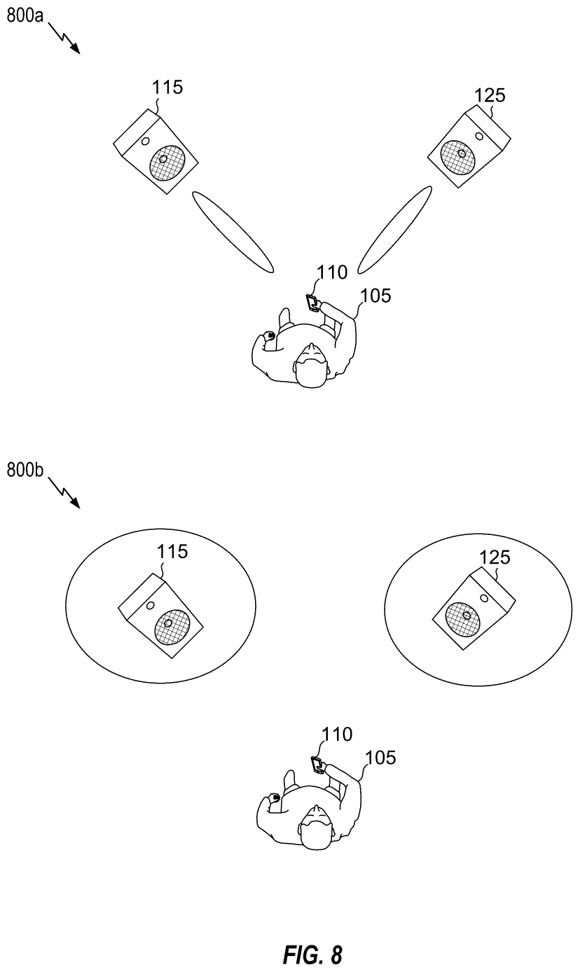

FIG. 8 illustrates example directivity control for a pair of loudspeakers, such as the loudspeakers 115 and 125 of the example multimedia system 100. As shown, loudspeaker directivity may be used to provide a narrow configuration 800a. In the narrow configuration 800a, the directivity may be applied to focus the audio signal to a small listening area. In an intermediate configuration, the directivity may be applied to focus the audio signal to a wider listening area. And in the wide configuration 800b, the directivity may be applied to focus the audio signal to a large listening area, for example, sending the audio signal in many directions. The wide configuration 800b may also be referred to as a “room-fill” or “omni” configuration, intended to transmit the audio signal in many directions to accommodate multiple listeners in a large listening area.

One technique for controlling loudspeaker directivity is beamforming. Although beamforming techniques are described herein, it should be understood that aspects of the present disclosure may be performed using any loudspeaker directivity techniques including, but not limited to, delay-and-sum processing, frequency shaping, and spatial sound field synthesis.

Traditional loudspeaker systems emit sound waves omnidirectionally or with limited control over the dispersion pattern. In applications requiring precise sound delivery-such as conference rooms, auditoriums, or smart devices-uncontrolled sound propagation results in acoustic inefficiencies, including interference, reverberation, and sound energy loss. Beamforming is an advanced signal processing technique that allows the creation of controllable and directed sound fields by manipulating the phase and amplitude of sound waves emitted by an array of transducers. Beamforming technology enables sound to be “steered” toward specific areas or listeners, while simultaneously reducing sound intensity in undesired directions, thus improving clarity and energy efficiency.

Beamforming may involve an array of acoustic transducers, a signal processor (e.g., a digital signal processor (DSP)) configured to compute the phase and amplitude adjustments, and a control unit. The DSP may apply phase shifts to audio signals fed to individual transducers. The phase shifts may be applied to create constructive interference in the desired direction and destructive interference elsewhere, forming a directed sound beam. The DSP may scale the amplitude of the audio signals to adjust the relative intensity of sound emitted by each transducer, fine-tuning the shape and reach of the audio beam. By dynamically varying the phase shifts, the system can reorient the beam direction without physically moving the transducers, for example, using delay-and-sum or frequency-domain beamforming algorithms.

While FIGS. 6-8 describe example techniques for adaptive sweetspot compensation and control of loudspeaker directivity, the aspects of this disclosure may be applied to any adaptive sweetspot compensation technique and any control of loudspeaker directivity technique. For example, adaptive sweetspot compensation techniques and control of loudspeaker directivity are described in U.S. Pat. No. 10,448,190, titled LOUDSPEAKER DEVICE OR SYSTEM WITH CONTROLLED SOUND FIELDS, U.S. Pat. No. 10,741,166, titled ADJUSTABLE ACOUSTIC LENS AND LOUDSPEAKER ASSEMBLY, and U.S. Pat. No. 9,942,659, titled LOUDSPEAKER TRANSDUCER ARRANGEMENT FOR DIRECTIVITY CONTROL, all of which are incorporated herein by reference in their entireties.

### Example Audio Reproduction System with Control of Loudspeaker Directivity and Adaptive Sweetspot Compensation

As discussed above, adaptive sweetspot and loudspeaker directivity are both techniques for providing an enhanced experience to a listener, or listeners, to compensate for various loudspeaker-listener distances. Existing solutions, however, do not consider systems which can control both the adaptive sweetspot and the loudspeaker directivity. This may lead to conflicts between the adaptive sweetspot and loudspeaker directivity settings, resulting in a degraded auditory experience for the listener.

In one example, a listener may select the wide (omni or room-fill) directivity configuration (e.g., the wide configuration 800c as illustrated in FIG. 8) to provide a broad listening area. However, the system may have an adaptive sweetspot function, which targets the singular sweetspot listening location. In this case, the adaptive sweetspot setting targeting a particular listener location conflicts with the wide directivity setting. Aspects of the present disclosure provide solutions to resolve or avoid conflicts in systems that use both loudspeaker directivity control and adaptive sweet spot compensation.

According to certain aspects, the loudspeaker directivity may be automatically controlled as a function of the listener position. In some examples, the loudspeaker directivity may be automatically controlled as a function of the listener-loudspeaker distance. In some examples, the loudspeaker directivity may be automatically controlled as a function of the listener distance from the sweetspot location. In some examples, the loudspeaker directivity may be automatically controlled as a function of the listener distance from an effective sweetspot location as adapted by a sweetspot compensation function.

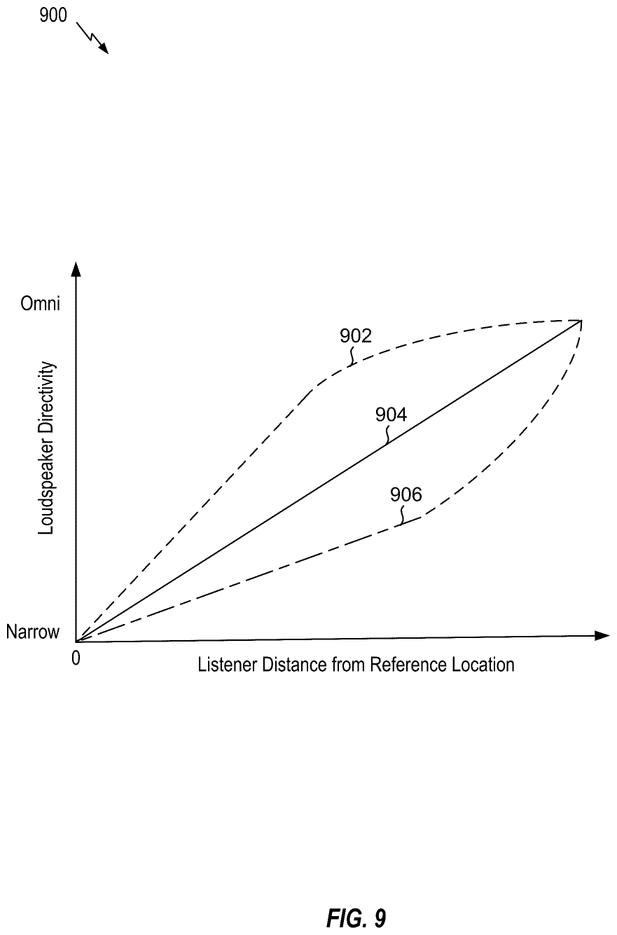

FIG. 9 illustrates an example plot 900 of loudspeaker directivity control based on listener distance from a reference location. As shown, when the listener is at the reference location (e.g., correctly positioned, as shown in the example in FIG. 3), narrow loudspeaker directivity may be applied. As further shown, as the distance of the listener from the reference point increases (e.g., as shown in the example in FIG. 5), the system applies wider loudspeaker directivity.

In some aspects, the function of the loudspeaker directivity based on the listener location may be configurable by the user. For example, FIG. 9 illustrates three different curves 902, 904, and 906, representing different functions of the loudspeaker directivity control based on the listener distance from the reference location.

According to certain aspects, the loudspeaker directivity is dynamically controlled automatically by the system based on positional data of the listener. In some example, adaptive sweetspot compensation may be enabled or disabled based on the level of loudspeaker directivity.

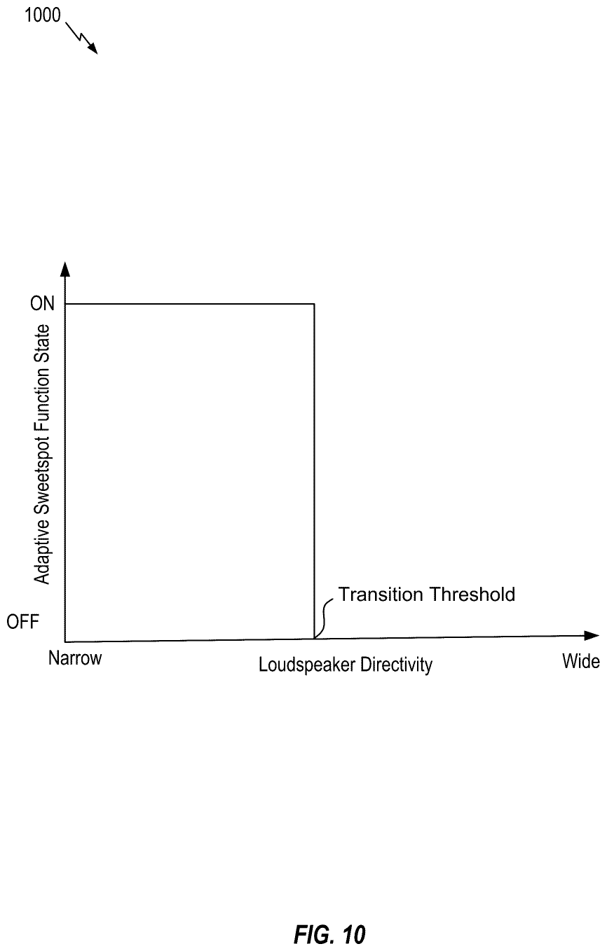

FIG. 10 illustrates an example plot 1000 of adaptive sweetspot function state as a function of loudspeaker directivity. In some examples, a transition threshold may be preconfigured or specified by the user. As shown, where the loudspeaker directivity is below the threshold (e.g., where the threshold is a threshold of narrow to omni directivity, being below the threshold being a narrower directivity and exceeding the threshold being a wider directivity), adaptive sweetspot compensation may be in an ON state (i.e., enabled), where adaptive sweetspot compensation is applied by the system. Where the loudspeaker directivity is at or above the threshold, adaptive sweetspot compensation may be in an OFF state (i.e., disabled), where adaptive sweetspot compensation is not applied.

The aspects described herein provide a technical solution to a technical problem associated with incorrect loudspeaker and listener positioning. More specifically, implementing the aspects herein allows for both adaptive sweetspot compensation and dynamic control of loudspeaker directivity to correct for the incorrect loudspeaker and listener positioning, while avoiding conflicts.

### Example Method for Adaptive Sweetspot Compensation and Dynamic Control of Loudspeaker Directivity

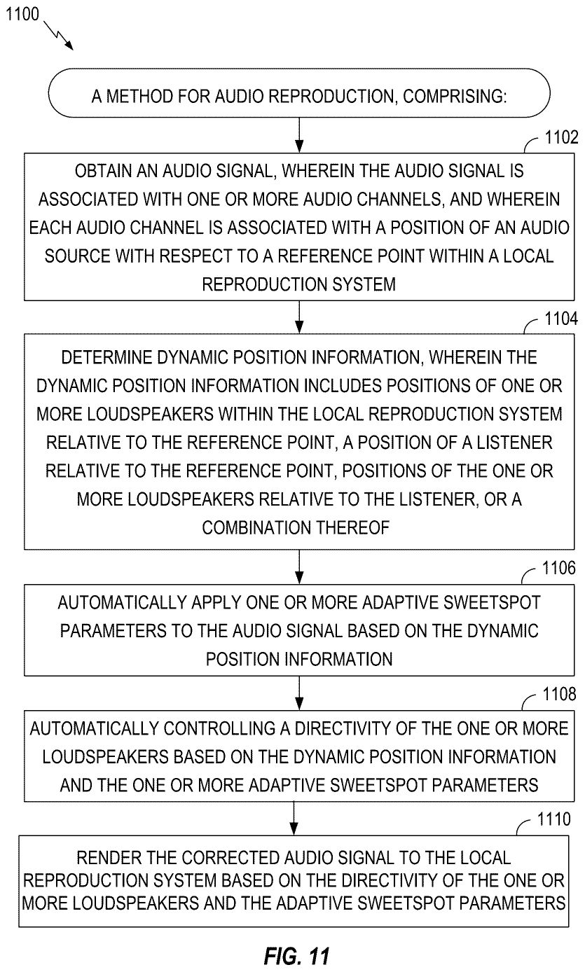

FIG. 11 is a flow diagram illustrating operations 1100 for audio reproduction, according to one or more aspects. The operations 1100 may be understood with reference to the FIGS. 1-10. The operations 1100 may be performed by a controller for an audio reproduction system (e.g., such as multimedia system 100). The controller may be located in a separate component within the audio reproduction system, may be located remotely (e.g., in a cloud), or may be integrated within another component of the audio reproduction system, such as a loudspeaker (e.g., such as loudspeaker 115 and/or 125).

Operations 1100 may begin, at operation 1102, with obtaining an audio signal. The audio signal is associated with one or more audio channels. Each audio channel is associated with a position of an audio source with respect to a reference point within a local reproduction system (e.g., multimedia system 100).

Operations 1100 include, at operation 1104, determining dynamic position information. The dynamic position information includes positions of one or more loudspeakers (e.g., loudspeaker 115, 120, 125, 130, and 135) within the local reproduction system relative to the reference point, a position of a listener relative to the reference point, positions of the one or more loudspeakers relative to the listener, or a combination thereof.

In some aspects, determining the dynamic position information, at operation 1104, includes continuously collecting position data of the one or more loudspeakers, the listener, or both. In some aspects, the dynamic position information comprises X-, Y-, and Z-Cartesian coordinates or Azimuth, elevation, and distance spherical coordinates. In some aspects, determining the dynamic position information, at 1104, includes, in response to a trigger, collecting position data of the one or more loudspeakers, the listener, or both, and wherein the dynamic position information comprises X-, Y-, and Z-Cartesian coordinates or Azimuth, elevation, and distance spherical coordinates. In some aspects, the trigger is a request from a user. In some aspects, the triggering is detecting that a location of the user has changed.

In some aspects, operations 1100 further includes determining, based on the dynamic position information, a distance of the listener from a sweetspot location. In some aspects, operations 1100 further include determining an effective sweetspot location based on the one or more adaptive sweetspot parameters. Determining the distance of the listener from the sweetspot location may include determining the distance of the listener from the effective sweetspot location.

Operations 1100 include, at operation 1106, automatically applying one or more adaptive sweetspot parameters to the audio signal based on the dynamic position information. In some aspects, automatically applying the one or more adaptive sweetspot parameters, at operation 1106, includes automatically applying one or more correction gains and one or more correction time delays to the audio signal based on the dynamic position information.

Operations 1100 include, at operation 1108, automatically controlling a directivity of the one or more loudspeakers based on the dynamic position information and the one or more adaptive sweetspot parameters.

In some aspects, automatically controlling the directivity of the one or more loudspeakers, at operation 1108, includes narrowing the directivity of the one or more loudspeakers in response to determining the listener is closer to the sweetspot location. In some aspects, automatically controlling the directivity of the one or more loudspeakers, at operation 1108, includes widening the directivity of the one or more loudspeakers in response to determining the listener is further from the sweetspot location.

In some aspects, the automatically controlling the directivity of the one or more loudspeakers, at operation 1108, is based on a predefined function of the distance of the listener from the sweetspot location.

In some aspects, the automatically controlling the directivity of the one or more loudspeakers, at operation 1108, includes applying active beamforming to the audio signal.

Operations 1100 include, at operation 1110, rendering the corrected audio signal to the local reproduction system based on the directivity of the one or more loudspeakers and the adaptive sweetspot parameters.

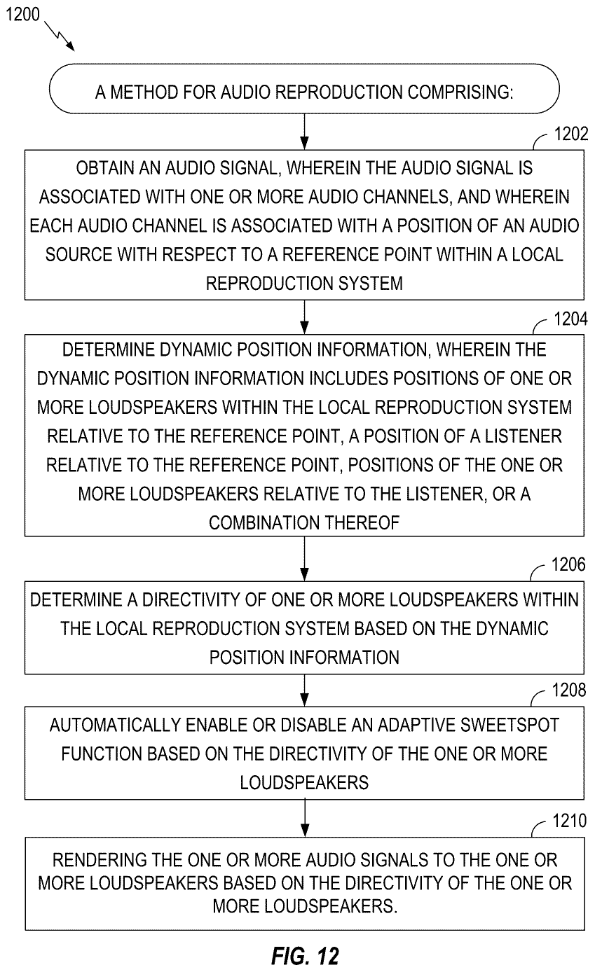

FIG. 12 is a flow diagram illustrating operations 1200 for audio reproduction, according to one or more aspects. The operations 1200 may be understood with reference to the FIGS. 1-10. The operations 1200 may be performed by a controller for an audio reproduction system (e.g., such as multimedia system 100). The controller may be located in a separate component within the audio reproduction system, may be located remotely (e.g., in a cloud), or may be integrated within another component of the audio reproduction system, such as a loudspeaker (e.g., such as loudspeaker 115 and/or 125).

Operations 1200 may begin, at operation 1202, obtaining an audio signal. The audio signal is associated with one or more audio channels. Each audio channel is associated with a position of an audio source with respect to a reference point within a local reproduction system.

Operations 1200 may include, at operation 1204, determining dynamic position information. The dynamic position information includes positions of one or more loudspeakers within the local reproduction system relative to the reference point, a position of a listener relative to the reference point, positions of the one or more loudspeakers relative to the listener, or a combination thereof.

In some aspects, determining the dynamic position information, at operation 1204, includes continuously collecting position data of the one or more loudspeakers, the listener, or both. The dynamic position information includes X-, Y-, and Z-Cartesian coordinates or Azimuth, elevation, and distance spherical coordinates.

In some aspects, determining the dynamic position information, at operation 1204, includes, in response to a trigger, collecting position data of the one or more loudspeakers, the listener, or both. The dynamic position information includes X-, Y-, and Z-Cartesian coordinates or Azimuth, elevation, and distance spherical coordinates. In some aspects, the trigger is a request from a user. In some aspects, the triggering includes detecting that a location of the user has changed.

Operations 1200 may include, at operation 1206, determining a directivity of one or more loudspeakers within the local reproduction system based on the dynamic position information. In some aspects, determining the directivity of the one or more loudspeakers within the local reproduction system based on the dynamic position information, at operation 1206, includes automatically controlling of directivity of the one or more loudspeakers based on the dynamic position information. In some aspects, the automatically controlling the directivity of the one or more loudspeakers comprises applying active beamforming to the audio signal.

Operations 1200 may include, at operation 1208, automatically enabling or disabling an adaptive sweetspot function based on the directivity of the one or more loudspeakers.

In some aspects, the operations 1200 further include comparing the determined directivity to a specified threshold level of directivity. The automatically enabling or disabling the adaptive sweetspot function, at operation 1208, may include enabling the adaptive sweet spot function in response to the directivity being below the threshold level and, in response to enabling the adaptive sweetspot function, automatically applying one or more adaptive sweetspot parameters to the audio signal based on the dynamic position information.

In some aspects, the automatically applying the one or more adaptive sweetspot parameters, at operation 1208, includes automatically applying one or more correction time delays, and in some cases further applying one or more correction gains, to the audio signal based on the dynamic position information.

In some aspects, the operations 1200 include comparing the determined directivity to a specified threshold level of directivity. In some aspects, the automatically enabling or disabling the adaptive sweetspot function, at operation 1208, includes disabling the adaptive sweet spot function in response to the directivity being at or above the threshold level. In some aspects, the threshold level is preconfigured or specified by a user.

Operations 1200 may include, at operation 1210, rendering the one or more audio signals to the one or more loudspeakers based on the directivity of the one or more loudspeakers. In some aspects, the rendering the one or more audio signals to the one or more loudspeakers is further based on the one or more adaptive sweetspot parameters.

### Example Dynamic Loudspeaker Directivity Control and Adaptive Sweetspot Compensation Device

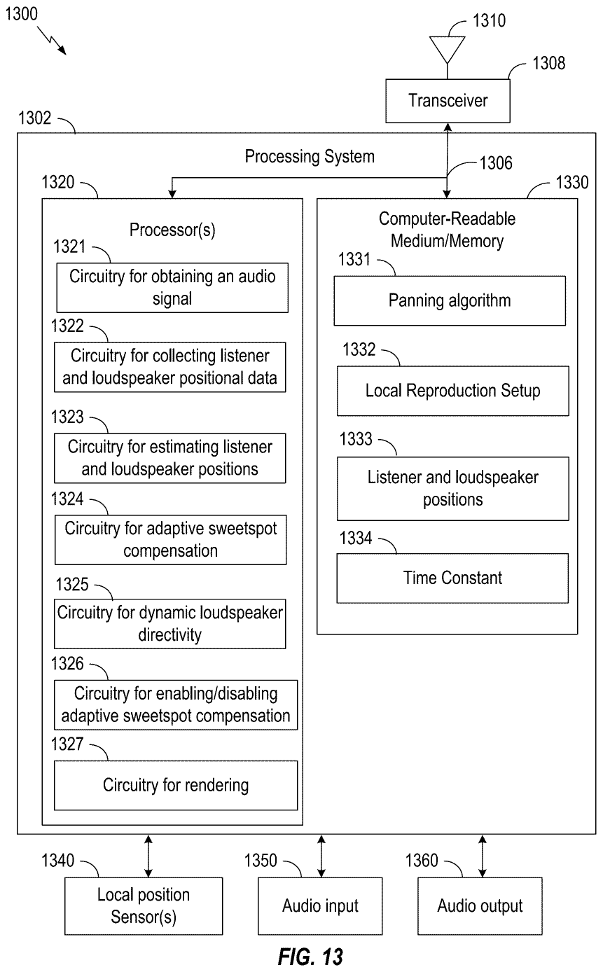

FIG. 13 depicts aspects of an example device 1300 for adaptive sweetspot compensation and dynamic control of loudspeaker directivity. In some aspects, device 1300 is an input controller. In some aspects, device 1300 is a loudspeaker, such as one of the loudspeakers 115, 120, 125, 130, and 135 described above with respect to FIG. 1. While shown as a single device 1300, in some aspects, components of device 1300 may be implemented across multiple physical devices within a multimedia system, such as multimedia system 100 described above with respect to FIG. 1, and/or within a network, such as by server 145 within network 140.

The device 1300 includes a processing system 1302 coupled to a transceiver 1308 (e.g., a transmitter and/or a receiver). The transceiver 1308 is configured to transmit and receive signals for the device 1300 via an antenna 1310, such as the various signals as described herein. The processing system 1302 may be configured to perform processing functions for the device 1300, including processing signals received and/or to be transmitted by the device 1300.

The processing system 1302 includes one or more processors 1320. The one or more processors 1320 are coupled to a computer-readable medium/memory 1330 via a bus 1306. In certain aspects, the computer-readable medium/memory 1330 is configured to store instructions (e.g., computer-executable code) that when executed by the one or more processors 1320, cause the one or more processors 1320 to perform the operations 1100 and/or 1200 described with respect to FIG. 11 and/or FIG. 12, or any aspect related to it. Note that reference to a processor performing a function of device 1300 may include one or more processors performing that function of device 1300.

The one or more processors 1320 include circuitry configured to implement (e.g., execute) the aspects described herein for adaptive sound image width enhancement, including circuitry for obtaining an audio signal 1321, circuitry for collecting listener and loudspeaker positional data 1322, circuitry for estimating listener and loudspeaker positions 1323, circuitry for adaptive sweetspot compensation 1324, circuitry for dynamic loudspeaker directivity 1325, circuitry for enabling and disabling adaptive sweetspot compensation 1326, and circuitry for rendering 1327. Processing with circuitry 1321-1327 may cause the device 1300 to perform the operations 1100 and/or 1200 described with respect to FIG. 11 and/or FIG. 12, or any aspect related to it.

In the depicted example, computer-readable medium/memory 1330 stores code (e.g., executable instructions). Processing of the code may cause the device 1300 to perform the operations 1100 and/or 1200 described with respect to FIG. 11 and/or FIG. 12, or any aspect related to it. In addition, computer-readable medium/memory 1330 may store information that can be used by the processors 1320. For example, computer-readable medium/memory 1330 may store a panning algorithm 1331, local reproduction setup information 1332, listener and loudspeaker positions 1333, and time constant(s) 1334.

In addition, the device 1300 may include a local position sensor(s) 1340 configured to collect raw listener and loudspeaker position data provided to the circuitry for estimating the listener and loudspeaker positions 1323. The device 1300 may also include a wired audio input 1350 and a wired audio output 1360, for obtaining and outputting audio signals.

### Example Aspects

Therefore, from one perspective, there have been described techniques for audio reproduction including determining dynamic position information including positions of one or more loudspeakers and/or a listener within the local reproduction system relative to a reference point. A method includes automatically applying one or more adaptive sweetspot parameters to an audio signal based on the dynamic position information and automatically controlling a directivity of the one or more loudspeakers based on the dynamic position information and the one or more adaptive sweetspot parameters. A method includes determining a directivity of the loudspeaker within the local reproduction system based on the dynamic position information and automatically enabling or disabling an adaptive sweetspot function based on the directivity of the loudspeaker. The methods include rendering the corrected audio signal to the local reproduction system based on the directivity of the one or more loudspeakers and the adaptive sweetspot parameters.

In addition to the various aspects described above, specific combinations of aspects are within the scope of the disclosure, some of which are detailed below:

Aspect 1: A method of audio reproduction, the method comprising: obtaining an audio signal, wherein the audio signal is associated with one or more audio channels, and wherein each audio channel is associated with a position of an audio source with respect to a reference point within a local reproduction system; determining dynamic position information, wherein the dynamic position information includes positions of one or more loudspeakers within the local reproduction system relative to the reference point, a position of a listener relative to the reference point, positions of the one or more loudspeakers relative to the listener, or a combination thereof; automatically applying one or more adaptive sweetspot parameters to the audio signal based on the dynamic position information; automatically controlling a directivity of the one or more loudspeakers based on the dynamic position information and the one or more adaptive sweetspot parameters; and rendering the corrected audio signal to the local reproduction system based on the directivity of the one or more loudspeakers and the adaptive sweetspot parameters.

Aspect 2: The method of Aspect 1, further comprising determining, based on the dynamic position information, a distance of the listener from a sweetspot location.

Aspect 3: The method of Aspect 2, further comprising determining an effective sweetspot location based on the one or more adaptive sweetspot parameters, wherein the determining the distance of the listener from the sweetspot location comprises determining the distance of the listener from the effective sweetspot location.

Aspect 4: The method of any combination of Aspect 2-3, wherein the automatically controlling the directivity of the one or more loudspeakers comprises narrowing the directivity of the one or more loudspeakers in response to determining the listener is closer to the sweetspot location.

Aspect 5: The method of any combination of Aspect 2-4, wherein the automatically controlling the directivity of the one or more loudspeakers comprises widening the directivity of the one or more loudspeakers in response to determining the listener is further from the sweetspot location.

Aspect 6: The method of any combination of Aspects 2-5, wherein the automatically controlling the directivity of the one or more loudspeakers is based on a predefined function of the distance of the listener from the sweetspot location.

Aspect: 7: The method of any combination of Aspects 1-6, wherein the automatically applying the one or more adaptive sweetspot parameters comprises automatically applying at least one of: one or more correction gains or one or more correction time delays to the audio signal based on the dynamic position information.

Aspect 8: The method of any combination of Aspects 1-7, wherein determining the dynamic position information comprises continuously collecting position data of the one or more loudspeakers, the listener, or both, and wherein the dynamic position information comprises X-, Y-, and Z-Cartesian coordinates or Azimuth, elevation, and distance spherical coordinates.

Aspect 9: The method of any combination of Aspects 1-7, wherein determining the dynamic position information comprises, in response to a trigger, collecting position data of the one or more loudspeakers, the listener, or both, and wherein the dynamic position information comprises X-, Y-, and Z-Cartesian coordinates or Azimuth, elevation, and distance spherical coordinates.

Aspect 10: The method of Aspect 9, wherein the trigger comprises a request from a user.

Aspect 11: The method of Aspect 9, wherein the trigger comprises detecting that a location of the user has changed.

Aspect 12: The method of any combination of Aspects 1-11, wherein the automatically controlling the directivity of the one or more loudspeakers comprises applying active beamforming to the audio signal.

Aspect 13: A method of audio reproduction, the method comprising: obtaining an audio signal, wherein the audio signal is associated with one or more audio channels, and wherein each audio channel is associated with a position of an audio source with respect to a reference point within a local reproduction system; determining dynamic position information, wherein the dynamic position information includes positions of one or more loudspeakers within the local reproduction system relative to the reference point, a position of a listener relative to the reference point, positions of the one or more loudspeakers relative to the listener, or a combination thereof, determining a directivity of the one or more loudspeakers within the local reproduction system based on the dynamic position information; automatically enabling or disabling an adaptive sweetspot function based on the directivity of the one or more loudspeakers; and rendering the one or more audio signals to the one or more loudspeakers based on the directivity of the one or more loudspeakers.

Aspect 14: The method of Aspect 13, further comprising: comparing the determined directivity to a specified threshold level of directivity, wherein the automatically enabling or disabling the adaptive sweetspot function comprises enabling the adaptive sweet spot function in response to the directivity being below the threshold level; and in response to enabling the adaptive sweetspot function, automatically applying one or more adaptive sweetspot parameters to the audio signal based on the dynamic position information, wherein the rendering the one or more audio signals to the one or more loudspeakers is further based on the one or more adaptive sweetspot parameters.

Aspect 15: The method of Aspect 14, wherein the automatically applying the one or more adaptive sweetspot parameters comprises automatically applying at least one of: one or more correction gains or one or more correction time delays to the audio signal based on the dynamic position information.

Aspect 16: The method of any combination of Aspects 13-15, further comprising comparing the determined directivity to a specified threshold level of directivity, wherein the automatically enabling or disabling the adaptive sweetspot function comprises disabling the adaptive sweet spot function in response to the directivity being at or above the threshold level.

Aspect 17: The method of any combination of Aspects 15-16, wherein the threshold level is preconfigured or specified by a user.

Aspect 18: The method of any combination of Aspects 13-17, wherein the determining the directivity of the one or more loudspeakers within the local reproduction system based on the dynamic position information comprises automatically controlling directivity of the one or more loudspeakers based on the dynamic position information.

Aspect 19: The method of Aspect 18, wherein the automatically controlling the directivity of the one or more loudspeakers comprises applying active beamforming to the audio signal.

Aspect 20: The method of any combination of Aspects 13-19, wherein determining the dynamic position information comprises continuously collecting position data of the one or more loudspeakers, the listener, or both, and wherein the dynamic position information comprises X-, Y-, and Z-Cartesian coordinates or Azimuth, elevation, and distance spherical coordinates.

Aspect 21: The method of any combination of Aspects 13-19, wherein determining the dynamic position information comprises, in response to a trigger, collecting position data of the one or more loudspeakers, the listener, or both, and wherein the dynamic position information comprises X-, Y-, and Z-Cartesian coordinates or Azimuth, elevation, and distance spherical coordinates.

Aspect 22: The method of Aspect 21, wherein the trigger comprises a request from a user.

Aspect 23: The method of Aspect 21, wherein the trigger comprises detecting that a location of the user has changed.

Aspect 24: An apparatus comprising means for performing a method in accordance with any of Aspects 1-23.

Aspect 25: A computer-readable medium comprising executable instructions that, when executed by one or more processors of an apparatus, cause the apparatus to perform a method in accordance with any of Aspects 1-23.

Aspect 26: A computer program product embodied on a computer-readable storage medium comprising code for performing a method in accordance with any of Aspects 1-23.

Aspect 27: An apparatus comprising: a memory comprising executable instructions and one or more processors configured to execute the executable instructions and cause the apparatus to perform a method in accordance with any of Aspects 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration. In the case of software, this many include computer and/or processor executable code that when executed causes a computer to carry out any of the various operations of methods described above. Such code may include instructions and may be provided by way of a computer readable medium. A computer-readable medium may be provided by way of a computer-readable storage medium and/or a computer-readable transmission medium. A computer-readable storage medium may be referred to as a non-transitory computer-readable medium. Examples of a computer-readable storage medium may include a CD, a DVD, a storage device, a diskette, a tape, flash memory, physical memory, or any other computer-readable storage medium. A computer-readable transmission medium, by which instructions may be conveyed, may include carrier waves, transmission signals or the like. A computer-readable transmission medium may convey instructions between components of a single computer system and/or between plural separate computer systems.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of audio reproduction, the method comprising:
obtaining an audio signal, wherein the audio signal is associated with one or more audio channels, and wherein each audio channel is associated with a position of an audio source with respect to a reference point within a local reproduction system;
determining dynamic position information, wherein the dynamic position information includes positions of one or more loudspeakers within the local reproduction system relative to the reference point, a position of a listener relative to the reference point, positions of the one or more loudspeakers relative to the listener, or a combination thereof;
automatically applying one or more adaptive sweetspot parameters to the audio signal based on the dynamic position information;
automatically controlling a directivity of the one or more loudspeakers based on the dynamic position information and the one or more adaptive sweetspot parameters; and
rendering the corrected audio signal to the local reproduction system based on the directivity of the one or more loudspeakers and the adaptive sweetspot parameters.

2. The method of claim 1, further comprising determining, based on the dynamic position information, a distance of the listener from a sweetspot location.

3. The method of claim 2, wherein the automatically controlling the directivity of the one or more loudspeakers comprises narrowing the directivity of the one or more loudspeakers in response to determining the listener is closer to the sweetspot location.

4. The method of claim 2, wherein the automatically controlling the directivity of the one or more loudspeakers comprises widening the directivity of the one or more loudspeakers in response to determining the listener is further from the sweetspot location.

5. The method of claim 2, wherein the automatically controlling the directivity of the one or more loudspeakers is based on a predefined function of the distance of the listener from the sweetspot location.

6. The method of claim 1, wherein the automatically applying the one or more adaptive sweetspot parameters comprises automatically applying at least one of: one or more correction gains or one or more correction time delays to the audio signal based on the dynamic position information.

7. The method of claim 1, wherein determining the dynamic position information comprises continuously collecting position data of the one or more loudspeakers, the listener, or both, and wherein the dynamic position information comprises X-, Y-, and Z-Cartesian coordinates or Azimuth, elevation, and distance spherical coordinates.

8. The method of claim 1, wherein determining the dynamic position information comprises, in response to a trigger, collecting position data of the one or more loudspeakers, the listener, or both, and wherein the dynamic position information comprises X-, Y-, and Z-Cartesian coordinates or Azimuth, elevation, and distance spherical coordinates.

9. The method of claim 8, wherein the trigger comprises a request from the listener.

10. The method of claim 8, wherein the trigger comprises detecting that a location of the listener has changed.

11. The method of claim 1, wherein the automatically controlling the directivity of the one or more loudspeakers comprises applying active beamforming to the audio signal.

12. A system for audio reproduction, the system comprising:
a local reproduction system including one or more loudspeakers;
a location sensor configured to collect raw position data, wherein the raw position data includes positions of the one or more loudspeakers, a position of a listener relative to a reference point in the system, positions of the one or more loudspeakers relative to the listener, or a combination thereof,
one or more control units configured to:
obtain an audio signal, wherein the audio signal is associated with one or more audio channels, and wherein each audio channel is associated with a position of an audio source with respect to a reference point within the local reproduction system;
determine dynamic position information from the raw position data, wherein the dynamic position information includes positions of the one or more loudspeakers within the local reproduction system relative to the reference point, a position of a listener relative to the reference point, positions of the one or more loudspeakers relative to the listener, or a combination thereof,
automatically apply one or more adaptive sweetspot parameters to the audio signal based on the dynamic position information; and
automatically control a directivity of the one or more loudspeakers based on the dynamic position information and the one or more adaptive sweetspot parameters; and
a renderer configured to render the audio signal to the local reproduction system based on the directivity of the one or more loudspeakers and the adaptive sweetspot parameters.

13. The system of claim 12, wherein the one or more control units are configured to determine, based on the dynamic position information, a distance of the listener from a sweetspot location.

14. The system of claim 13, wherein the automatically controlling the directivity of the one or more loudspeakers comprises narrowing the directivity of the one or more loudspeakers in response to determining the listener is closer to the sweetspot location.

15. The system of claim 13, wherein the automatically controlling the directivity of the one or more loudspeakers comprises widening the directivity of the one or more loudspeakers in response to determining the listener is further from the sweetspot location.

16. The system of claim 13, wherein the automatically controlling the directivity of the one or more loudspeakers is based on a predefined function of the distance of the listener from the sweetspot location.

17. A non-transitory computer readable medium comprising computer executable code for audio reproduction, the computer executable code comprising:
code for obtaining an audio signal, wherein the audio signal is associated with one or more audio channels, and wherein each audio channel is associated with a position of an audio source with respect to a reference point within a local reproduction system;
code for determining dynamic position information, wherein the dynamic position information includes positions of one or more loudspeakers within the local reproduction system relative to the reference point, a position of a listener relative to the reference point, positions of the one or more loudspeakers relative to the listener, or a combination thereof,
code for automatically applying one or more adaptive sweetspot parameters to the audio signal based on the dynamic position information;
code for automatically controlling a directivity of the one or more loudspeakers based on the dynamic position information and the one or more adaptive sweetspot parameters; and
code for rendering the corrected audio signal to the local reproduction system based on the directivity of the one or more loudspeakers and the adaptive sweetspot parameters.

18. The non-transitory computer readable medium of claim 17, further comprising code for determining, based on the dynamic position information, a distance of the listener from a sweetspot location.

19. The non-transitory computer readable medium of claim 18, wherein the code for automatically controlling the directivity of the one or more loudspeakers comprises code for narrowing the directivity of the one or more loudspeakers in response to determining the listener is closer to the sweetspot location.

20. The non-transitory computer readable medium of claim 18, wherein the code for automatically controlling the directivity of the one or more loudspeakers comprises code for widening the directivity of the one or more loudspeakers in response to determining the listener is further from the sweetspot location.
